(19) United States
(12) Patent Application Publication
(10) Pub. No.: US 2025/0284521 A1
(43) Pub. Date: Sep. 11, 2025

(54) METHODS AND APPARATUS TO DYNAMICALLY CONFIGURE DELAY DURATIONS AND/OR CORE POWER STATES IN VIRTUAL COMPUTING ENVIRONMENTS

(71) Applicant: Intel Corporation, Santa Clara, CA (US)

(72) Inventors: Jaishankar Rajendran, Bangalore (IN); Vaibhav Shankar, Lake Stevens, WA (US); Rajshree A Chabukswar, Sunnyvale, CA (US); Prashant B Kodali, Camas, WA (US)

(73) Assignee: Intel Corporation, Santa Clara, CA (US)

(21) Appl. No.: 18/964,391

(22) Filed: Nov. 30, 2024

(30) Foreign Application Priority Data
Oct. 10, 2024 (IN) 202441076932

(51) Int. Cl. G06F 9/455; G06F 9/48

(52) U.S. Cl. CPC G06F 9/45558; G06F 9/4893

(57) ABSTRACT

A disclosed example accesses a workload type indicator associated with a workload executed on a virtual machine hosted by an apparatus; and sets a delay duration in a configuration register. the delay duration based on at least one of the workload type indicator or a temperature measurement value corresponding to hardware.

### RELATED APPLICATION

This patent claims the benefit of Indian Provisional Patent Application No. 202441076932, which was filed on Oct. 10, 2024. Indian Provisional Patent Application No. 202441076932 is hereby incorporated herein by reference in its entirety. Priority to Indian Provisional Patent Application No. 202441076932 is hereby claimed.

### BACKGROUND

In virtual computing, a virtual machine manager (VMM) or hypervisor can run on a host operating system (OS) executing on a physical host machine. The VMM manages virtual resources supported by underlying physical resources of the host machine. One or more virtual machines (VMs) can run on the VMM. The VMM can allocate virtual resources to the one or more VMs. The VMM manages startups, allocations of virtual resources, deallocations of virtual resources, and shutdowns of the VMs.

### BRIEF DESCRIPTION OF THE DRAWINGS

FIG. 1 is a block diagram of an example environment in which an example processor capabilities manager operates to dynamically configure pause delay durations and/or core power states in virtual computing environments.

FIG. 2 is a block diagram of the example environment of FIG. 1 in which a maximum pause delay duration is used in a TPAUSE instruction to delay execution of a halt instruction.

FIG. 3 is an example parameter configurations table that stores workload type hints in association with power and delay parameter configuration values.

FIG. 4 is a block diagram of an example implementation of the processor capabilities manager of FIGS. 1 and 2.

FIG. 5 is a flowchart representative of example machine readable instructions and/or example operations that may be executed, instantiated, and/or performed by example programmable circuitry to implement the virtual environment of FIG. 1 to halt a virtual central processor unit (vCPU).

FIG. 6 is a flowchart representative of example machine readable instructions and/or example operations that may be executed, instantiated, and/or performed by example programmable circuitry to implement the processor capabilities manager of FIG. 4 to dynamically set delay durations and core power states in a configuration register of a processor.

FIG. 7 is another flowchart representative of example machine readable instructions and/or example operations that may be executed, instantiated, and/or performed by example programmable circuitry to implement the processor capabilities manager of FIG. 4 to dynamically set delay durations and core power states in a configuration register of a processor.

FIG. 8 is a block diagram of an example processing platform including programmable circuitry structured to execute, instantiate, and/or perform the example machine readable instructions and/or perform the example operations of FIGS. 5-7 to implement the processor capabilities manager of FIG. 4.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 5-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawings and accompanying written description to refer to the same or like parts. The figures are not necessarily to scale.

### DETAILED DESCRIPTION

Some processors (e.g., a 12th Generation Intel Core processor) feature a performance hybrid architecture that combines Performance-cores (P-cores) and Efficiency-cores (E-cores), enhancing the overall user experience. In such a design, P-cores are designed to boost performance for complex workloads with limited threading, and E-cores are optimized for multi-threaded throughput and scenarios that prioritize power efficiency.

In a virtual machine (VM) environment, a VM Exit event (e.g., based on a VM Exit instruction) marks the point at which a switch is made between a VM that is currently running and a virtual machine manager (VMM) (e.g., a hypervisor) when the VMM is to exercise system control for a particular reason, such as, to process privileged instructions (e.g., a halt (HLT) instruction), exceptions, interrupts, reads of configuration registers (e.g., Model-Specific Register (MSR) reads, Memory-Mapped Input-Output (MMIO) reads, etc.). In some systems, the VMM/hypervisor traps VM Exit events and serves the VM Exit events to a host operating system (OS) of a physical host machine. Subsequently, during a VM Enter event, control is switched back from the VMM to the VM.

To process a VM Exit event, the physical processor of the host machine may perform several operations including: (1) recording information about the VM Exit reasons (e.g., request halting of an idle vCPU), (2) saving processor state in a guest state area of memory, (3) saving VM hardware register values (e.g., Model-Specific Register (MSR) values) in a VM Exit MSR store area of memory, (4) loading processor state from a host state area and loading VM Exit controls for a host processor, and (5) loading VMM hardware register values (e.g., MSR values) from a VM Exit MSR load area into corresponding hardware registers (e.g., MSR registers). The operations of (2) saving processor state in the guest state area and (3) saving VM hardware register values in the VM Exit MSR store area are performed to save a snapshot of the VM's state as it was running at the time of the VM Exit event so that the VM's state can be subsequently restored during a later VM Enter event. The operations of (4) loading processor state from a host state area and (5) loading VMM hardware register values are performed to instantiate a context of the VMM in a host machine to run the VMM.

To process a VM Enter event, the physical processor of the host machine may perform the same operations of the VM Exit event but in reverse order. For example, the host machine (1) records information about completion of the VM Exit reasons (e.g., a requested halting of an idle vCPU has been completed), (2) saves processor state in a host area of memory, (3) saves VMM hardware register values (e.g., MSR values) in an MSR store area, (4) loads processor state from the guest state area and loads VM Entry controls for a host processor, and (5) loads VM hardware register values (e.g., MSR values) from the VM Exit MSR store area to corresponding hardware registers (e.g., MSRs). The operations of (2) saving processor state in a host area of memory and (3) saving hardware register values (e.g., MSR values) in an MSR store area are performed to save a snapshot of the VMM state as it was running at the time of the VM Entry event so that the VMM's state can be subsequently restored during a later VM Exit event. The operations of (4) loading processor state from the guest state area and (5) loading hardware register values (e.g., MSR values) from the VM Exit MSR store area are performed to instantiate a context of the VM in the host machine to run the VM.

VM Exit events that are triggered in response to certain instructions and events (e.g., page fault events) are a significant source of performance degradation in a virtualized system. For example, processing VM Exit events and subsequent VM Entry events to switch between a VM and a VMM creates the processing overhead to perform the VM Exit and VM Entry operations described above. The latencies introduced by such processing overhead create performance hits for workloads running on the guest OS of the VM. For example, after the VMM has performed its system management function(s) in response to a VM Exit event, a corresponding VM Entry is performed that transitions processor control from the VMM to the VM. To process the VM Entry event, the above-noted steps to process the VM Exit event are performed in reverse order. As such, a VM Exit generates considerable overhead (e.g., hundreds or thousands of cycles for a single transition).

Within a VM, threads are allocated to virtual central processor units (vCPUs) for processing and are then scheduled on physical CPUs (pCPUs). In a VM environment, a vCPU enters an idle state if it has no threads to process. A pCPU enters a sleep state during inactivity. If the idle vCPU lacks subsequent threads to process or preempt and it remains idle, a guest OS of the VM sends a request to halt (e.g., a halt (HLT) instruction) the vCPU, leading to a VM Exit triggered by an HLT Event. For example, in response to executing the halt instruction, the corresponding pCPU is halted and the VM Exit event is processed to exit the VM. In some instances, after the HLT instruction stops execution activities of the vCPU and a physical core (e.g., a core of a pCPU) allocated to the vCPU goes to a halt state, an interrupt (e.g., an interrupt to process a thread) occurs to wake the core before a corresponding VM Exit is processed. In such cases, the vCPU is not exited but instead resumes to handle the interrupt. However, if an interrupt to wake the core does not occur, control is trapped in the VMM and is scheduled for transferring out to the host machine. For example, a kernel-based virtual machine (KVM) schedule out (KVM SCHED OUT) event causes the control to be transferred to a host scheduler of the host machine to move the halted physical core of the pCPU to one or more deeper power states (e.g., lower power states) if there are no other threads to be scheduled in the pCPU. In such instances, the VMM reschedules or reallocates the vCPU, allowing another vCPU thread to occupy the pCPU previously used or engaged by the halted vCPU thread.

In some systems, to introduce delay between the time a vCPU goes idle and a time that the VM executes a HLT instruction includes the use of a timed event instruction referred to as a TPAUSE instruction. In such systems, before the HLT instruction is executed, the guest OS initiates the TPAUSE instruction to implement a maximum polling duration specified in the TPAUSE instruction. Accordingly, the TPAUSE instruction is triggered before the halt instruction. The TPAUSE instruction instructs the pCPU to enter an optimized power/performance state with a pre-determined maximum pause delay. The pre-determined maximum pause delay, also referred to as a polling time, is based on a core C-state (e.g., a core power state) of the host pCPUs. If the polling time expires before a wake-up interrupt (e.g., an interrupt to process a thread) is received, the HLT instruction is executed to halt the vCPU of the VM, and a VM Exit event is processed to move the core of the corresponding pCPU to one or more deeper power states (e.g., lower power states). Alternatively, should a wake-up interrupt occur within this polling time period, the paused vCPU resumes execution.

However, in some such systems, the pre-determined maximum pause delay, or polling time, is statically set and tied to the core C-state of a pCPU. For example, a User Level Monitor Wait (“UMWAIT”) MSR that stores a pre-determined maximum pause delay operates on a fixed configuration, not taking into account the type of workload being processed. This means that once the maximum pause delay configuration is set for a vCPU, it remains unchanged for the duration of the instance of that vCPU. As such, the pre-determined maximum pause delay, or polling time, is not configurable outside the predetermined value of a corresponding core C-state. This leads to significant performance and power efficiency losses in VM workloads. In addition, this is not ideal for hybrid environments that combine P-cores and E-cores. For example, a significant limitation of the above-described systems is the static configuration of the maximum pause delay for the TPAUSE instruction, which fails to account for the nuances of hybrid architectures. In some systems, a hybrid system-on-chip (SoC) featuring P-cores and E-cores does not intelligently decide on which pCPU to execute a TPAUSE instruction. This, coupled with the differing minimum and maximum frequencies of P-cores and E-cores, means that a non-optimal polling time setting can lead to reduced performance and increased power consumption in VM workloads. In some instances, 30 frames per second (FPS) is a suitable cadence to balance power and performance.

Unlike systems that have statically pre-defined maximum pause delays, or polling times, examples disclosed herein adjust core C-states (e.g., for power savings and/or performance gains) and maximum pause delay durations, or polling times, independent of one another for the TPAUSE instruction in substantially real time. To do so, examples disclosed herein utilize metrics such as the host system pCPU's idle and utilization rates, energy-performance preference (EPP), system workload profiles, workload concurrency, performance/efficiency classification, and/or power/thermal limitations. Examples disclosed herein determine configuration priorities of core C-states and maximum pause delay durations based on at least one of thermal temperatures of the SoC and/or the chassis, and workload types determined based on one or more of the host system pCPU's idle and utilization rates, the EPP, the system workload profiles, the workload concurrency, the performance/efficiency classification, and/or the power/thermal limitations. Examples disclosed herein enhance performance of a host machine and its hosted VMs by minimizing CPU cycles wasted on halt events and VM Exit events. Examples disclosed herein also optimize efficiencies of host machines in terms of polling times and core C-states.

Examples disclosed herein reduce overhead from VM Exit events (e.g., VM Exit HLT events) which conserves CPU cycles in virtualization environments to improve processing performance on hybrid platforms that use P-cores and E-cores. For example, examples disclosed herein enhance performance by minimizing CPU cycles wasted on VM Exit HLT Events and optimizing polling efficiency. Examples disclosed herein also enhance battery life for VM scenarios through efficient usage and polling of P and E cores on hybrid platforms. Examples disclosed herein dynamically adjust core C-states and maximum pause delay durations in substantially real time based on substantially real-time hardware operating characteristics (e.g., substantially real-time thread characteristic data provided by an Enhanced Hardware Feedback Interface (“EHFI”) of hardware). For example, dynamic adjustments of UMWAIT MSR settings (e.g., core C-states and maximum pause delay durations), guided by workload type hints generated based on, for example, host system pCPU idle and utilization rates, EPP, system workload profiles, workload concurrency, performance/efficiency classification, power/thermal limitations, etc., optimizes polling times more precisely, yielding improvements in both performance and power efficiency. Examples disclosed herein improve hardware power efficiency through power savings due to optimized pCPU resource utilization. Examples disclosed herein may be used to implement a more power-optimized state of a virtualization environment during vCPU idle periods.

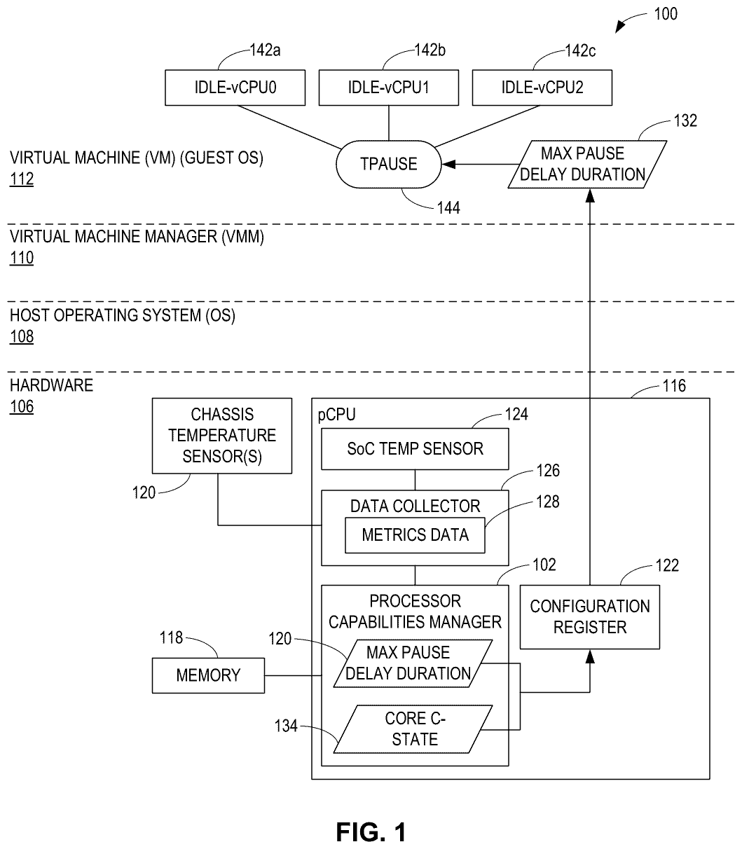

FIG. 1 is a block diagram of an example virtual computing environment 100 in which an example processor capabilities manager 102 operates to dynamically configure pause delay durations and/or core power states (e.g., core C-states). The virtual computing environment 100 includes example hardware 106, an example host OS 108, an example VMM 110 (e.g., a hypervisor), and an example VM 112. In example FIG. 1, the host OS 108 executes on the hardware 106, the VMM 110 executes on the host OS 108, the VM 112 executes on the VMM 110, and one or more guest OS's execute on the VM 112. The VMM 110 creates a virtualization environment by virtualizing physical resources of the hardware 106 into virtual (or logical) resources and allocating the virtual resources to the VM 112 or other VMs executing on the VMM 110.

In example FIG. 1, the hardware 106 implements a host machine (e.g., a host server, a host computer, a host processor system, etc.) that includes an example pCPU 116, example memory 118, and one or more example chassis temperature sensor(s) 120. In the illustrated example of FIG. 1, the pCPU 116 is a SoC that includes multiple subsystems on a single chip, such as, one or more cores, one or more levels of cache, registers, memory, etc. In the example of FIG. 1, the pCPU 116 includes the example processor capabilities manager 102, an example configuration register 122, and an example SOC temperature sensor 124. For purposes of brevity, other details of the pCPU 116 are omitted from FIG. 1. The memory 118 may be any suitable volatile or non-volatile memory and may be internal or external to the pCPU 116.

The chassis temperature sensor(s) 120 sense(s) one or more temperature(s) of a chassis in which the hardware 106 (e.g., the pCPU 116 and the chassis temperature sensor(s) 120 are located). For example, the one or more chassis temperature sensor(s) 120 may be placed at different locations of a motherboard. Example chassis temperature sensors 120 include a memory temperature sensor, an ambient temperature sensor, a charger circuit temperature sensor, and a communication circuit temperature sensor. For example, a memory temperature sensor (e.g., a dual data rate (DDR) synchronous dynamic random access memory (SDRAM) system on chip (SoC) temperature sensor) may be placed near one or more memory chip(s) (e.g., one or more DDR-SDRAM/SoC chip(s)) on the motherboard. An ambient temperature sensor may be placed on the motherboard at a location conducive to monitoring ambient temperature in a chassis in which the hardware 106 is located. A charger circuit temperature sensor may be located near a charger circuit on the motherboard. A communication circuit temperature sensor (e.g., a wireless wide-area network (WWAN) temperature sensor) may be placed near a communications chip (e.g., a WWAN chip) on the motherboard. Examples disclosed herein may be implemented with any additional or alternative type of chassis temperature sensor 120. The SoC temperature sensor 124 senses a chip temperature of the pCPU 116.

In example FIG. 1, the configuration register 122 is a hardware register that stores configuration information associated with the pCPU 116 and/or associated with processes that run on the pCPU 116. In some examples, the configuration register 122 is implemented by a Model-Specific Register (MSR). In other examples, the configuration register 122 is implemented by a Memory-Mapped Input-Output (MMIO) register. In yet other examples, the configuration register 122 may be implemented by any other suitable type of register. In other examples, multiple configuration registers may be provided in the pCPU 116.

In example FIG. 1, the processor capabilities manager 102 includes an example data collector 126 that collects example metrics data 128. The data collector 126 collects some of the metrics data 128 from, for example, the pCPU 116, the chassis temperature sensor(s) 120, and/or the SoC temperature sensor 124. In some examples, the processor capabilities manager 102 accesses the metrics data 128 via a hardware interface (e.g., an Enhanced Hardware Feedback Interface (“EHFI”)) of the data collector 126 and stores the metrics data 128 in the memory 118. In examples disclosed herein, the metrics data 128 is information about the hardware 106 that the processor capabilities manager 102 uses to dynamically determine an example maximum pause delay duration value 132 and/or an example core C-state setting 134. For example, the processor capabilities manager 102 uses operating characteristics about the hardware 106 represented in the metrics data 128 at the time of determining the maximum pause delay duration value 132 and/or the core C-state setting 134.

The processor capabilities manager 102 loads the maximum pause delay duration value 132 and the core C-state setting 134 in the configuration register 122. As such, the VM 112 can use a hypervisor call through the VMM 110 to access the maximum pause delay duration value 132 and/or the core C-state setting 134 from the configuration register 122. In examples in which the configuration register 122 is implemented as an MSR, the processor capabilities manager 102 loads the maximum pause delay duration value 132 and the core C-state setting 134 in a IA32_UMWAIT_CONTROL field of the MSR. For example, the IA32_UMWAIT_CONTROL field of the MSR includes 32 bits, of which bits 1-31 represent the maximum pause delay duration value 132 and bit 0 represents the core C-state setting 134. In some examples, the maximum pause delay duration value 132 and the core C-state setting 134 may be stored in separate MSR registers.

In examples disclosed herein, the maximum pause delay duration value 132 is also referred to as a maximum polling time or maximum polling duration and represents the amount of time that elapses between a first time at which a vCPU (e.g., one of the vCPUs 142a-c) enters an idle state and a second time at which the VM 112 executes a halt (HLT) instruction to halt the idle vCPU. In examples disclosed herein, polling and poll refer to delaying of an event. For example, the vCPU can be polled to extend the duration in which the vCPU remains in an idle state, thus delaying execution of a HLT instruction to halt the idle vCPU (e.g., deallocate the idle vCPU from the VM 112). As such, the maximum pause delay duration value 132, or maximum polling time/duration, controls how long to pause or poll the idle vCPU before halting it. In some examples, the idle vCPU is in a sleep state during its paused or polled duration.

In examples disclosed herein, the core C-state setting 134 is also referred to as a polling state or polling type and represents a core power mode in which the pCPU 116 is to operate. The core C-state setting 134 controls processing modes of the pCPU 116 during the polling of the idle vCPU. For example, the processor capabilities manager 102 can set the core C-state setting 134 to a performance mode (e.g., the core C-state setting 134 is set to C0.1—Performance Mode) or to a higher power savings mode (e.g., the core C-state setting 134 is set to C0.2—Power Saving Mode) depending on whether power savings or performance gains would benefit the host OS 108 more during the polling of the idle vCPU. In other examples, the processor capabilities manager 102 may set the core C-state setting 134 to any other suitable mode (e.g., a power mode that trades off between computing performance and power consumption).

In examples disclosed herein, the processor capabilities manager 102 dynamically changes the maximum pause delay duration value 132 and/or the core C-state setting 134 based on the metrics data 128 collected by the data collector 126 during operation of the hardware 106 and its related virtual environment(s). The dynamic changing of the maximum pause delay duration value 132 optimizes the pause duration that the VM 112 should wait for an interrupt before the VM 112 requests that an idle vCPU be halted. Accordingly, examples disclosed herein optimize polling times (e.g., the maximum pause delay duration value 132) in a more precise manner relative to current workloads and operating characteristics of the hardware 106 so that the polling duration of an idle vCPU is commensurate with a current performance of the hardware 106 and its related virtual environment(s). In addition, the dynamic changing of the core C-state setting 134 can be used to optimize tradeoffs between performance and power savings of the pCPU 116 during the pausing or polling of the idle vCPU. As such, by dynamically changing the maximum pause delay duration value 132 and/or the core C-state setting 134 based on the metrics data 128, the processor capabilities manager 102 improves both performance and power efficiency of the hardware 106 and its related virtual environment(s).

Optimizing the pause duration for the VM 112 (through the maximum pause delay duration value 132) before an idle vCPU is halted can improve resource usage and performance of the VM 112, the VMM 110, the host OS 108, and/or the hardware 106. The vCPU may be halted for a number of reasons. For example, the vCPU may have finished processing all of its threads and is waiting for another thread. Alternatively, a thread of the vCPU is currently halted awaiting an action by the VMM 110, the host OS 108, the hardware 106, or another VM. In any case, the idling time of a vCPU awaiting another thread to process or awaiting action on a currently halted thread may vary depending on one or more operating characteristics of the hardware 106 represented in the metrics data 128.

For example, different operating characteristics may result in slower or faster speeds of hardware such as physical cores of the pCPU 116. When slower speeds are implemented in the hardware, causing the pCPU 116 to process at slower rates, the pCPU 116 takes longer to process halted threads or allocate new threads to vCPUs. As such, by using the operating characteristics of the hardware 106 to dynamically change the pause duration of a VM 112 before an idle vCPU is halted, the pause duration can optimize the amount of time that is appropriate to wait for a halted thread to be processed by the pCPU 116 or to wait for the pCPU 116 to issue a new thread to the idle vCPU.

The pause duration (e.g., the maximum pause delay duration value 132) for an idle vCPU can be optimized to be reasonably long enough to wait for thread activity without stalling the processing of other threads for such a long duration that it decreases performance of the virtual computing environment 100 to an unacceptable level. Making the pause duration (e.g., the maximum pause delay duration value 132) too short increases the risk that a currently halted thread will be processed shortly after an idle vCPU is halted, resulting in needing to resume the vCPU through VM Exit and VM Enter events in a relatively short amount of time after its halting. Additionally, making the pause duration (e.g., the maximum pause delay duration value 132) too short increases the risk that a subsequent new thread will be allocated for the idle vCPU shortly after it is halted, resulting in needing to also resume the vCPU through VM Exit and VM Enter events in a relatively short amount of time after its halting.

Dynamically adjusting the pause duration (e.g., the maximum pause delay duration value 132) commensurate with current operating characteristics of the hardware 106 reduces processing overhead of activities related to halting and resuming a vCPU. That is, the halting and resuming of a vCPU consumes many resources of the virtual computing environment 100 relative to having instead paused the idle vCPU for a longer amount of time so that it could be quickly resumed upon receipt of subsequent thread activity without needing to process VM Exit and VM Enter events. For example, each time an HLT instruction is executed to halt a vCPU, the virtual computing environment 100 processes the multiple operations described above for a VM Exit event and a VM Enter event. In addition, to resume the vCPU from the halted state, the virtual computing environment 100 again processes the multiple operations for the VM Enter and VM Exit events. This creates significant processing overhead for the virtual computing environment 100 to halt vCPUs and resume vCPUs from halted states.

Example information that may be represented in the metrics data 128 includes one or more chassis temperature(s) collected from the chassis temperature sensor(s) 120, a chip temperature collected from the SoC temperature sensor 124, an idle rate of one or more pCPUs of the hardware 106, a utilization rate of the one or more pCPUs, an energy-performance preference, system workload profiles, a workload concurrency, a performance classification, an efficiency classification, a power limitation of the hardware 106, or a thermal limitation of the hardware 106.

In examples disclosed herein, one or more chassis temperature(s) collected from the chassis temperature sensor(s) 120 and/or a chip temperature collected from the SoC temperature sensor 124 may be used by the processor capabilities manager 102 to vary the pause duration of an idle vCPU. For example, such temperatures may cause slower or faster speeds of hardware such as physical cores of the pCPU 116. Such speed variations at different times cause the hardware 106 to process thread activities (e.g., act on halted threads, allocate new threads to vCPUs, etc.) at different rates.

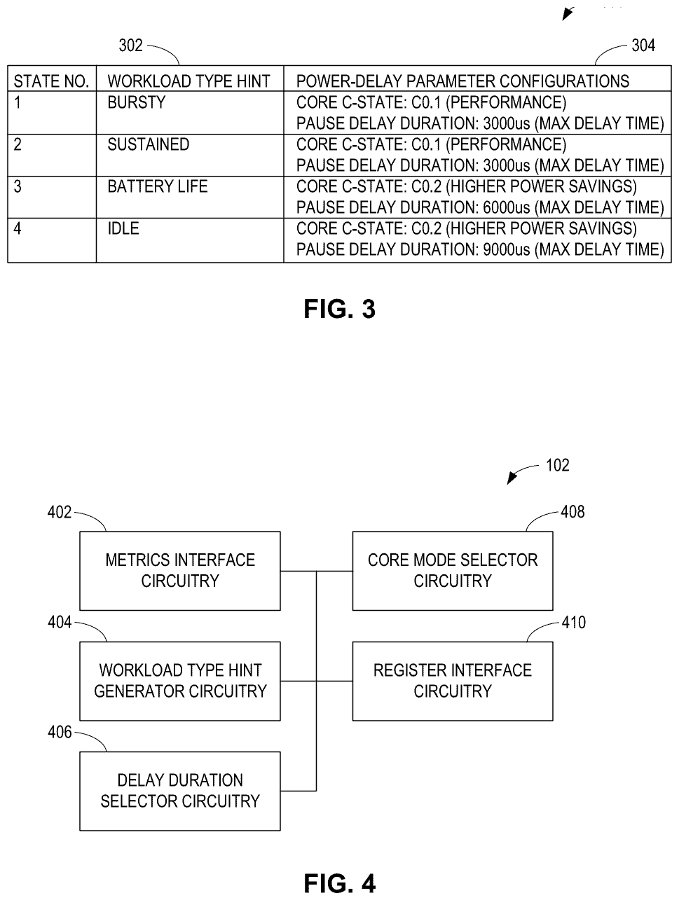

In examples disclosed herein, an idle rate of one or more pCPUs of the hardware 106 represents how often the one or more pCPUs have entered into an idle state (e.g., due to not having threads to process, due to overheating, due to maintaining performance below a selected performance classification, etc.) over a past window of time. In examples disclosed herein, a utilization rate of the one or more pCPUs represents how often the one or more pCPUs are active (e.g., processing threads) over a past window of time. In examples disclosed herein, an energy-performance preference is indicative of a power state level (e.g., an energy consumption level) that is selected for one or more pCPUs of the hardware 106. In examples disclosed herein, a system workload profile refers to types of workloads being processed by the pCPU 116 and include, for example, ‘Bursty’ workloads, ‘Sustained’ workloads, ‘Battery Life’ workloads, and ‘Idle’ workloads. The different types of workloads are described below in connection with workload type hints of FIG. 3.

In examples disclosed herein, a workload concurrency represents a number of workloads that have been concurrently processed by one or more pCPUs of the hardware 106 over a past window of time. In examples disclosed herein, a performance classification is indicative of a type of computing performance (e.g., a pCPU clock speed) selected for one or more pCPUs of the hardware 106. In examples disclosed herein, an efficiency classification is indicative of a target efficiency selected to balance energy/power consumption and computing performance of one or more pCPUs of the hardware 106. In examples disclosed herein, a power limitation of the hardware 106 represents a maximum power/energy consumption threshold/limit selected for one or more pCPUs of the hardware 106. In examples disclosed herein, a thermal limitation of the hardware 106 represents a maximum temperature threshold/limit for a chassis temperature and/or a chip temperature at which the hardware 106 can operate before reducing performance and/or halting operations.

The above operating characteristics of the hardware 106 of chassis temperature, chip temperature, idle rate, utilization rate, energy-performance preference, system workload profiles, workload concurrency, performance classification, efficiency classification, power limitation, and thermal limitation can be used to infer recent processing speeds of the one or more pCPUs (e.g., the pCPU 116) of the hardware 106. By representing these operating characteristics in the metrics data 128 and updating the operating characteristics from time to time (e.g., synchronously, asynchronously, at a selected interval, based on interrupts, etc.), the processor capabilities manager 102 has a current view (e.g., a substantially real-time view) into the processing performance or processing speed to expect from the hardware 106 for thread processing activities. When the metrics data 128 represents a slower processing performance or speed, the processor capabilities manager 102 can increase the maximum pause delay duration value 132 based on the metrics data 128 to accommodate a longer pause duration for the pCPU 116 to service a halted thread for an idle one of the vCPUs 142a-c or to allocate new threads to the idle one of the vCPUs 142a-c. Alternatively, when the metrics data 128 represents a faster processing performance or speed, the processor capabilities manager 102 can decrease the maximum pause delay duration value 132 based on the metrics data 128 based on the expectation that a shorter pause duration is sufficient for the pCPU 116 to service a halted thread for an idle one of the vCPUs 142a-c or to allocate new threads to the idle one of the vCPUs 142a-c.

In some examples, the processor capabilities manager 102 uses the operating characteristics in the metrics data 128 to generate different workload type hints. In examples disclosed herein, a workload type hint (e.g., a workload type indicator) is a high level descriptor or summary that reflects an overall processing performance of the hardware 106 and/or software executing on the hardware 106. In examples disclosed herein, workload type hints account for a combination of one or more of the above-described operating characteristics. In such examples, the processor capabilities manager 102 uses the workload type hints to determine the maximum pause delay duration value 132 and/or the core C-state setting 134. Example workload type hints are described in more detail below in connection with FIG. 3.

In some instances, not all of the vCPUs 142a-c corresponding to the guest OS of the VM 112 are in a constantly active state. As such, when one or more of the vCPUs 142a-c is/are idle, this causes the VM 112 to issue a HLT request to transition those idle ones of the vCPUs 142a-c to a halt state (e.g., a C1 sleep state). The halt state is the shallowest sleep state for a core and is referred to as a C1 sleep state (e.g., core C-state=C1). The halt state consumes less power than an active C0 core C-state (e.g., core C-state=C0) but more power than deeper C3-C7 low power states (e.g., core C-states of C3-C7). In examples disclosed herein, a core C-state of C0 is the highest performance core power state, a core C-state of C1 (e.g., clocks are gated) provides lower core performance and higher power savings than C0, a core C-state of C6 (e.g., caches are flushed) provides lower core performance and higher power savings than C1, and a core C-state of C7 provides the most core power savings and lowest core performance relative to C0, C1, and C6. Introducing the maximum pause delay duration value 132 based on the metrics data 128 in accordance with examples disclosed herein enhances performance and power efficiency of the hardware 106 and the virtual computing environment 100. For example, though a HLT state places a vCPU in the lower power consumption C1 sleep state, this lower power consumption sleep state may not provide sufficient power savings to justify the amount of processing associated with VM Exit and VM Enter events to halt an idle vCPU and resume it from its halted state. Accordingly, selecting a suitable delay value for the maximum pause delay duration value 132 as disclosed herein can avoid the resource usage associated with VM Exit and VM Enter events when processing HLT instructions for idle vCPUs.

In examples disclosed herein, the processor capabilities manager 102 monitors the metrics data 128 and dynamically updates the maximum pause delay duration value 132 and/or the core C-state setting 134 from time to time based on the metrics data 128. Such dynamic updating keeps the maximum pause delay duration value 132 and/or the core C-state 134 current and relevant to the current operating characteristics of the hardware 106. As such, the maximum pause delay duration value 132 used for a TPAUSE instruction (e.g., the TPAUSE instruction 144) is commensurate with a current processing performance or speed of the hardware 106.

The processor capabilities manager 102 can perform the dynamic updating of the maximum pause delay duration value 132 and/or the core C-state setting 134 based on a configured time interval, based on detected changes in the metrics data 128, and/or based on interrupts. For example, a user-defined or process-defined time interval may be programmed in the processor capabilities manager 102 to cause the processor capabilities manager 102 to dynamically update the maximum pause delay duration value 132 and/or the core C-state setting 134 based on a current state of the metrics data 128. Additionally or alternatively, the processor capabilities manager 102 can be programmed to dynamically update the maximum pause delay duration value 132 and/or the core C-state setting 134 when the processor capabilities manager 102 detects a change in the metrics data 128. Additionally or alternatively, the processor capabilities manager 102 can be programmed to dynamically update the maximum pause delay duration value 132 and/or the core C-state setting 134 in response to interrupts, such as, a “Processor Hot” interrupt (e.g., a PROCHOT# interrupt) from the pCPU 116. For example, a PROCHOT# interrupt indicates the pCPU 116 has reached its maximum safe operating temperature and a Thermal Control Circuit (TCC) has activated. In some examples, the maximum safe operating temperature is 194 degrees Fahrenheit (90 degrees Celsius) and the TCC is used to begin cooling activities for the pCPU 116. In some examples, the cooling activities prevent the pCPU 116 from reaching a shutdown temperature (e.g., 212 degrees Fahrenheit or 100 degrees Celsius).

In some examples, the processor capabilities manager 102 can perform the dynamic setting/updating of the maximum pause delay duration value 132 and/or the core C-state setting 134 asynchronously. For example, such dynamic setting/updating can be asynchronous relative to the execution of an example TPAUSE instruction 144 (e.g., a pause instruction), asynchronous relative to changes in the metrics data 128, asynchronous relative to a “Processor Hot” interrupt (e.g., a PROCHOT# interrupt) from the pCPU 116, etc. As such, the maximum pause delay duration value 132 and the core C-state setting 134 are available in the configuration register 122 for access by the guest OS kernel of the VM 112 whenever the guest OS kernel of the VM 112 is to execute the TPAUSE instruction 144 to implement a delay based on the maximum pause delay duration value 132.

In example FIG. 1, the VM 112 includes one or more vCPUs shown by way of example as an example vCPU0 142a, an example vCPU1 142b, and an example vCPU2 142c. The vCPUs 142a-c are virtual resources supported by one or more pCPUs of the hardware 106, such as, the pCPU 116. For example, a physical core or a percentage of processing power of the pCPU 116 can be allocated to the vCPU0 142a and other cores or other percentages of processing power of the pCPU 116 can be allocated to the vCPU1 142b and the vCPU2 142c.

In example FIG. 1, the vCPUs 142a-c are shown as idle which means there are no threads needing to be processed by any of the vCPUs 142a-c. To control how long a vCPU 142a-c is maintained in an idle mode before halting the vCPU 142a-c (e.g., releasing the vCPU 142a-c to a virtual resource pool of the VMM 110), the VM 112 configures the example TPAUSE instruction 144 (e.g., a pause instruction) based on the maximum pause delay duration value 132 that the processor capabilities manager 102 stores in the configuration register 122. The maximum pause delay duration value 132 specifies a pause duration for the idle one of the vCPUs 142a-c. For example, the pause duration occurs between a first time at which one or more of the vCPUs 142a-c enter(s) an idle state and a second time at which a HLT instruction is executed by the VM 112 to halt the idle one or more of the vCPUs 142a-c. The pause duration represented by the maximum pause delay duration value 132 can also be referred to as an offset time between execution of the TPAUSE instruction 144 (which is in response to one or more of the vCPUs 142a-c entering an idle state) and execution of the HLT instruction. During the pause duration specified by the maximum pause delay duration value 132, the idle one or more of the vCPUs 142a-c remain(s) idle such that it/they is/are paused from being halted by the HLT instruction. In some examples, the idle one or more of the vCPUs 142a-c is/are in a sleep state during the pause duration.

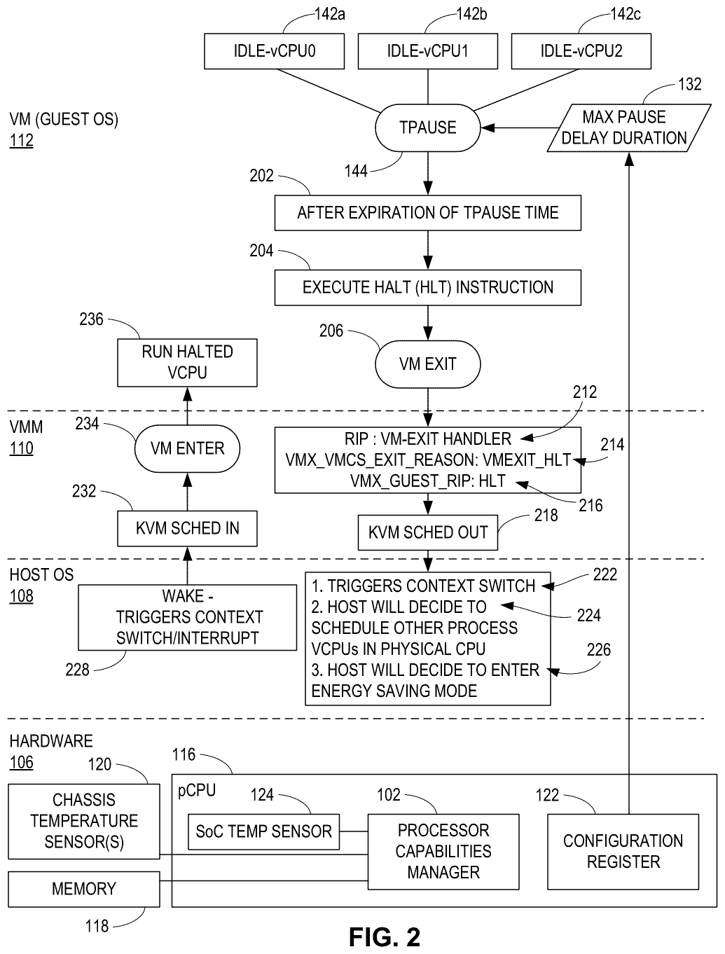

FIG. 2 is a block diagram of the example virtual computing environment 100 of FIG. 1 in which the maximum pause delay duration value 132 is used in the TPAUSE instruction 144 to delay execution of a halt instruction. In the VM 112, threads are allocated to the vCPUs 142a-c for execution and subsequently scheduled on one or more pCPU(s) of the hardware 106 such as the pCPU 116. When not in use, the pCPU(s) enter sleep modes. An idle one of the vCPUs 142a-c, with no threads to process or preempt, prompts the guest OS of the VM 112 to request its halting. In response to this halting request, the guest OS kernel of the VM 112 executes the TPAUSE instruction 144 to implement a pause duration for the idle one of the vCPUs 142a-c. For example, the guest OS of the VM 112 accesses the configuration register 122 (e.g., using a hypervisor call through the VMM 110) to retrieve the maximum pause delay duration value 132 and executes the TPAUSE instruction 144 based on the maximum pause delay duration value 132. For example, the guest OS of the VM 112 can set a ‘TPAUSE Time’ parameter of the TPAUSE instruction 144 equal to the maximum pause delay duration value 132. This creates a delay between a first time the idle one of the vCPUs 142a-c prompts the guest OS of the VM 112 for its halting and a second time at which the guest OS kernel executes a HLT instruction. This delay is used to poll the idle one of the vCPUs 142a-c to delay its halting for a duration during which a wake-up interrupt can be received that resumes the idle one of the vCPUs 142a-c. For example, the wake-up interrupt may be used to notify the idle one of the vCPUs 142a-c of a pending thread awaiting to be processed.

If a wake-up interrupt is received by the guest OS of the VM 112 during the polling of the idle one of the vCPUs 142a-c defined by the maximum pause delay duration value 132, the idle one of the vCPUs 142a-c is resumed (e.g., during the context of the VM 112 without needing to process VM Exit and VM Enter events). Otherwise, after expiration of the TPAUSE Time defined in the TPAUSE instruction 144 (block 202) without having received a wake-up interrupt, the guest OS of the VM 112 executes the HLT instruction (block 204) to perform the halting of the idle one of the vCPUs 142a-c. In the example of FIG. 2, the TPAUSE instruction 144 and the HLT instruction are executed by the guest OS kernel of the VM 112 as virtual machine extension (VMX) non-root operations. The execution of the HLT instruction triggers an example VM Exit event 206. In response to the VM Exit event 206, the VMM 110 halts and/or reallocates the vCPU (e.g., to another VM executing on the hardware 106 or to a virtual resource pool), allowing a different vCPU thread to utilize the pCPU 116, a portion of the pCPU 116, or a physical core of the pCPU 116 previously engaged by the halted one of the vCPUs 142a-c.

In the example of FIG. 2, the VMM 110 captures the VM Exit event 206. In response to the VM Exit event 206, the VMM 110 locates and executes a VM-Exit handler (212) based on a relative instruction pointer (RIP). The VMM 110 notes the exit reason (214) in a virtual machine control structure (VMCS) of a VMX (e.g., VMX_VMCS_EXIT_REASON: VMEXIT_HLT). For example, the VMM 110 notes the exit reason (214) as being attributed to a VM Exit triggered by a HLT instruction. In examples disclosed herein, the VMX is a set of processor hardware enhancements that enable a hypervisor (e.g., the VMM 110) to run multiple operating systems on a single physical host machine (e.g., the hardware 106). Also in examples disclosed herein, the VMCS is a data structure that controls the state of a VMs processor and VMM control. The VMM 110 also locates and executes an HLT routine based on RIP addressing (216). For example, the HLT routine can be performed by the VMM 110 to halt an idle one of the vCPUs 142a-c.

In addition, the VMM 110 executes a kernel virtual machine (KVM) schedule out (KVM SCHED OUT) instruction to swap hardware register values in the configuration register 122. For example, the VMM 110 saves VM hardware register values corresponding to the VM 112 from the configuration register 122 to a VM Exit MSR store area and loads VMM hardware register values (e.g., MSR values) from a VM Exit MSR load area into the configuration register 122. Control is then passed to the host OS 108.

In the example of FIG. 1, the host OS 108 triggers a context switch (222) from the VM 112 to the VMM 110. In addition, the host OS 108 decides whether to schedule other process vCPUs in the pCPU 116 (224). Also, the host OS 108 decides to enter an energy saving mode (226). At some subsequent time, the host OS 108 executes a wake handler (228) to generate a wake interrupt in the VMM 110 that triggers a context switch from the VMM 110 back to the VM 112. The wake interrupt may be, for example, a newly received workload (e.g., received asynchronously) to be processed by the VM 112 (e.g., by a vCPU 142a-c of the VM 112).

In response to the wake interrupt, the VMM 110 executes a KVM schedule in (KVM SCHED IN) instruction (232) to swap hardware register values in the configuration register 122. For example, the VMM 110 saves the VMM hardware register values corresponding to the VMM 110 from the configuration register 122 to an MSR store area and loads VM hardware register values (e.g., MSR values) from a VM Exit MSR store area into the configuration register 122. The VMM 110 then processes an example VM Enter event (234) and control is passed to the VM 112. The VM 112 runs the halted one of the vCPUs 142a-c (236).

As described above, the amount of processing related to VM Exit events (e.g., the VM Exit event 206) and VM Enter events (e.g., the VM Enter event 234) to halt an idle one of the vCPUs 142a-c and to re-start a halted vCPU 142a-c is significant. Using examples disclosed herein to dynamically configure the maximum pause delay duration value 132 and/or the core C-state setting 134 improves use of processing resources of the hardware 106, the host OS 108, and the VMM 110 by avoiding the VM Exit event 206 and VM Enter event 234 when an idle one of the vCPUs 142a-c is idle for only a short duration before it receives subsequent thread activity. For example, if that short duration is shorter than the maximum pause delay duration value 132, the VM Exit event 206 is avoided and the idle one of the vCPUs 142a-c resumes processing on a pending thread.

FIG. 3 is an example parameter configurations table 300 that stores workload type hints 302 (e.g., workload type indicators) in association with power and delay parameter configuration values 304. In some examples, the host OS 108 manages the capabilities of the pCPU 116 by causing the processor capabilities manager 102 to adjust the maximum pause delay duration value 132 and/or the core C-state setting 134 in the configuration register 122 based on feedback in the form of the metrics data 128. For example, the processor capabilities manager 102 may use temperature measures in the metrics data 128 and/or the workload type hints in the parameter configurations table 300.

The workload type hints 302 in the parameter configurations table 300 represent processing performance capabilities of the pCPU 116 to process workloads in the virtual computing environment 100 via vCPUs (e.g., the vCPUs 142a-c of FIGS. 1 and 2). Such processing intensities can be used as an indicator of how much lag may be expected in thread processing by the pCPU 116 (e.g., through one or more vCPUs). The workload type hints 302 include an example ‘Bursty’ workload type hint, an example ‘Sustained’ workload type hint, an example ‘Battery Life’ workload type hint, and an example ‘Idle’ workload type hint. The ‘Bursty’ workload type hint represents that the core C-state of the pCPU 116 is set to a higher processing performance mode (e.g., a core C-state setting 134 of C0.1) in which it is able to process multiple threads in burst-like fashion. The ‘Sustained’ workload type hint represents that the core C-state of the pCPU 116 is set to the higher processing performance mode (e.g., the core C-state setting 134 of C0.1) in which it is able to process a steady, sustained stream of threads. The ‘Battery Life’ workload type hint represents that the core C-state of the pCPU 116 is set to a higher power savings mode (e.g., a core C-state setting 134 of C0.2) in which processing resources of the pCPU 116 operate at a lower performance to conserve battery life. The ‘Idle’ workload type hint represents that the core C-state of the pCPU 116 is set to a higher power savings mode (e.g., a core C-state setting 134 of C0.2) in which processing resources of the pCPU 116 operate at a lower performance based on the pCPU 116 mostly entering an idle state. In some examples, the ‘Idle’ workload type hint represents that the chip temperature of the pCPU 116 is too high (e.g., due to a faulty component, a hot operating environment, etc.) and is awaiting cooling. In other examples, examples disclosed herein may be implemented using any other suitable workload type hint in addition to or instead of one or more of the workload type hints shown in FIG. 3.

In the example of FIG. 3, the power and delay parameter configuration values 304 include default delay duration values for the maximum pause delay duration value 132. For example, the ‘Bursty’ workload type hint and the ‘Sustained’ workload type hint have a default maximum pause delay duration value 132 of 3000 microseconds (us), the ‘Battery Life’ workload type hint has a default maximum pause delay duration value 132 of 6000 us, and the ‘Idle’ workload type hint has a default maximum pause delay duration value 132 of 9000 us. The default maximum pause delay duration values 132 represent how long the TPAUSE instruction 144 should poll an idle one of the vCPUs 142a-c to await subsequent thread activity before executing the HLT instruction (204) to halt the idle vCPU 142a-c. For example, when the workload type hint is ‘Bursty’ and the core C-state setting 134 is set to C0.1 (Performance), the pCPU 116 is able to process threads relatively quicker than when the workload type hint is ‘Battery Life’ or ‘Idle’. As such, the default maximum pause delay duration value 132 is set to 3000 us for the ‘Bursty’ workload type hint which is shorter than 6000 us for the ‘Battery Life’ workload type hint or 9000 us for the ‘Idle’ workload type hint. This means that the shorter 3000 us for the ‘Bursty’ workload type hint is a reasonable duration to poll the idle one of the vCPUs 142a-c because the higher performance mode (e.g., the core C-state setting 134 of C0.1) allows the pCPU 116 to generate thread activity faster. However, the longer 6000 us for the ‘Battery Life’ workload type hint or 9000 us for the ‘Idle’ workload type hint are reasonable durations to poll the idle one of the vCPUs 142a-c because the higher power savings mode (e.g., the core C-state setting 134 of C0.2) means the pCPU 116 is operating slower and will take more time to generate thread activity.

Although the power and delay parameter configuration values 304 include default delay duration values for the maximum pause delay duration value 132, the maximum pause delay duration values 132 associated with the different workload type hints can be changed dynamically to any other suitable values by the processor capabilities manager 102 based on current operating characteristics of the hardware 106 represented in the metrics data 128.

In some examples, temperature is used as a proxy for a performance capability of the hardware 106 (e.g., a high or low performance mode of the pCPU 116). For example, the processor capabilities manager 102 may be configured to use thermal temperatures as first-priority operating characteristics over the workload type hints of FIG. 3 to dynamically adjust the maximum pause delay duration value 132 and/or the core C-state setting 134. Using thermal measures may include comparing a chip temperature of the pCPU 116 (e.g., measured by the SoC temperature sensor 124) to a chip temperature threshold (e.g., 194 degrees Fahrenheit or 90 degrees Celsius) and/or one or more chassis temperature threshold(s) (e.g., one or more chassis passive trip temperature threshold(s) for one or more locations in a chassis of the hardware 106 at which the host OS 108 begins passive cooling). Alternatively, using thermal measures may include comparing one or more chassis temperature(s) to a chip temperature threshold and/or one or more chassis temperature threshold(s). In any case, using thermal measures and temperature thresholds to dynamically adjust the maximum pause delay duration value 132 and/or the core C-state setting 134, as disclosed herein, advantageously provides protection for the hardware 106 (e.g., the pCPU 116) from overheating. For example, dynamically adjusting the maximum pause delay duration value 132 and/or the core C-state setting 134 can be used to allow periods of cooling for the hardware 106 (e.g., the pCPU 116) while providing reasonable pause durations for idle ones of the vCPUs 142a-c to wait for the pCPU 116 to generate subsequent thread activity.

For example, if a chip temperature of the pCPU 116 (and/or one or more chassis temperature(s)) exceeds a chip temperature threshold or if the chip temperature (and/or one or more chassis temperature(s)) surpasses one or more chassis temperature threshold(s), the processor capabilities manager 102 sets the core C-state setting 134 to level C0.2 (indicating higher power savings) and sets the maximum pause delay duration value 132 to a relatively longer delay (e.g., 6000 us, 9000 us, 10000 us, etc.). Such a delay is selected to be relatively longer compared to a shorter delay (e.g., 1000 us, 2000 us, 3000 us, etc.) that would be suitable if the chip temperature of the pCPU 116 did not exceed a chip temperature threshold or one or more chassis temperature threshold(s).

In examples in which a maximum safe operating temperature for the pCPU 116 is 194 degrees Fahrenheit (90 degrees Celsius) and a shutdown temperature for the pCPU 116 and/or the hardware 106 is 212 degrees Fahrenheit (100 degrees Celsius), a maximum safe chip temperature threshold or a maximum safe chassis temperature threshold can be represented as 90% which is the percentage of the maximum safe operating temperature (e.g., 194 degrees Fahrenheit) relative to the shutdown temperature (e.g., 212 degrees Fahrenheit).

In examples disclosed herein, different components of the hardware 106 may be rated at different maximum safe operating temperatures. As such, chassis temperature thresholds may be selected based on a specific design of a chassis. For example, some chassis designs may have higher chassis passive trip temperature thresholds than other chassis designs due to their particular cooling features, airflow designs, etc. Different chassis temperature thresholds for different subsystems of the hardware 106 may be used for comparisons with temperature measures from different ones of the chassis temperature sensor(s) 120. Accordingly, the processor capabilities manager 102 may use different maximum safe chassis temperature thresholds to determine the maximum pause delay duration value 132 and/or the core C-state setting 134.

Chassis temperature threshold values may be set to different temperature values between 122 degrees Fahrenheit (50 degrees Celsius) and 248 degrees Fahrenheit (120 degrees Celsius). In some examples, the chassis temperature threshold values range from 122 degrees Fahrenheit to 158 degrees Fahrenheit (e.g., 50-70 degrees Celsius). Specific temperature values for chassis temperature thresholds depend on the thermal designs and dissipation capabilities of chassis, motherboards, and different components/subsystems of the hardware 106. For example, desktop computers and servers may have different thermal designs and dissipation capabilities than laptops. As such, different ones of the chassis temperature sensor(s) 120 located at different parts of a chassis or motherboard can have different thermal trip points (e.g., chassis temperature thresholds that activate cooling actions) because their temperature measures are likely not the same at all points in the chassis or on the motherboard.

Also as part of using thermal temperatures as first-priority operating characteristics over the workload type hints of FIG. 3, the generation of a PROCHOT# interrupt can trigger the processor capabilities manager 102 to adjust the core C-state setting 134 and/or the maximum pause delay duration value 132. For example, when the pCPU 116 is not too hot and the PROCHOT# interrupt has not been asserted, the processor capabilities manager 102 can set the core C-state setting 134 (e.g., the polling state) to the core C-state of C0.1 (indicating a performance mode). However, when the PROCHOT# interrupt is asserted indicating the pCPU 116 is too hot (e.g., a chip temperature of the pCPU 116 equals or exceeds a maximum safe operating temperature threshold of the pCPU 116), the processor capabilities manager 102 can adjust the core C-state setting 134 (e.g., the polling state) from the core C-state of C0.1 (indicating a performance mode) to the core C-state of C0.2 (indicating a higher power savings mode than C0.1) to allow cooling of the pCPU 116. In addition, the processor capabilities manager 102 can adjust the maximum pause delay duration value 132 from a shorter delay duration to a longer delay duration (e.g., a longer polling duration to poll an idle one of the vCPUs 142a-c before halting it).

In some examples, the processor capabilities manager 102 uses thermal temperatures in combination with the workload type hints of FIG. 3 to adjust the maximum pause delay duration value 132 and/or the core C-state setting 134. In some such examples, configurations of the maximum pause delay duration value 132 and/or the core C-state setting 134 based on thermal temperatures may have a higher configuration priority over configurations of the maximum pause delay duration value 132 and/or the core C-state setting 134 based on the workload type hints. Accordingly, cooling actions can be taken when elevated operating temperatures of the hardware 106 are detected, and hardware performance can be increased based on the workload type hints when safe operating temperatures of the hardware 106 are detected. However, in examples in which temperature measures are not available, the processor capabilities manager 102 uses the workload type hints of FIG. 3 without thermal temperature information to adjust the maximum pause delay duration value 132 and/or the core C-state setting 134.

FIG. 4 is a block diagram of an example implementation of the processor capabilities manager 102 of FIGS. 1 and 2 to adjust the maximum pause delay duration value 132 and/or the core C-state setting 134. The processor capabilities manager 102 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the processor capabilities manager 102 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The processor capabilities manager 102 includes example metrics interface circuitry 402, example workload type hint generator circuitry 404, example delay duration selector circuitry 406, example core mode selector circuitry 408, and example register interface circuitry 410. Although the metrics interface circuitry 402 and the workload type hint generator circuitry 404 are shown in the processor capabilities manager 102 in the example of FIG. 4, in other examples, one or both of the metrics interface circuitry 402 and the workload type hint generator circuitry 404 may instead be implemented in the data collector 126 (FIG. 1).

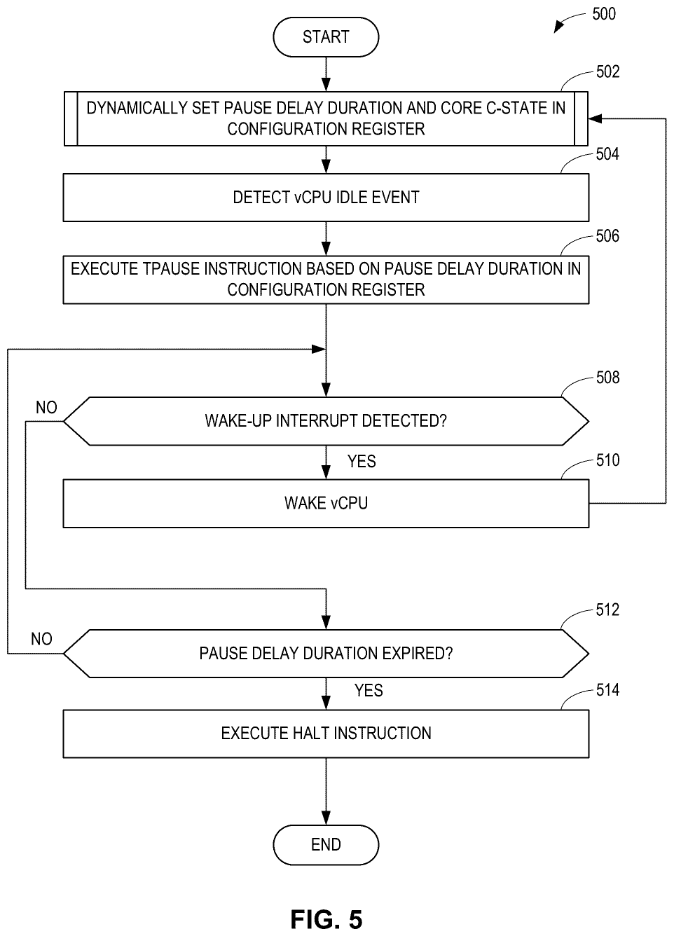

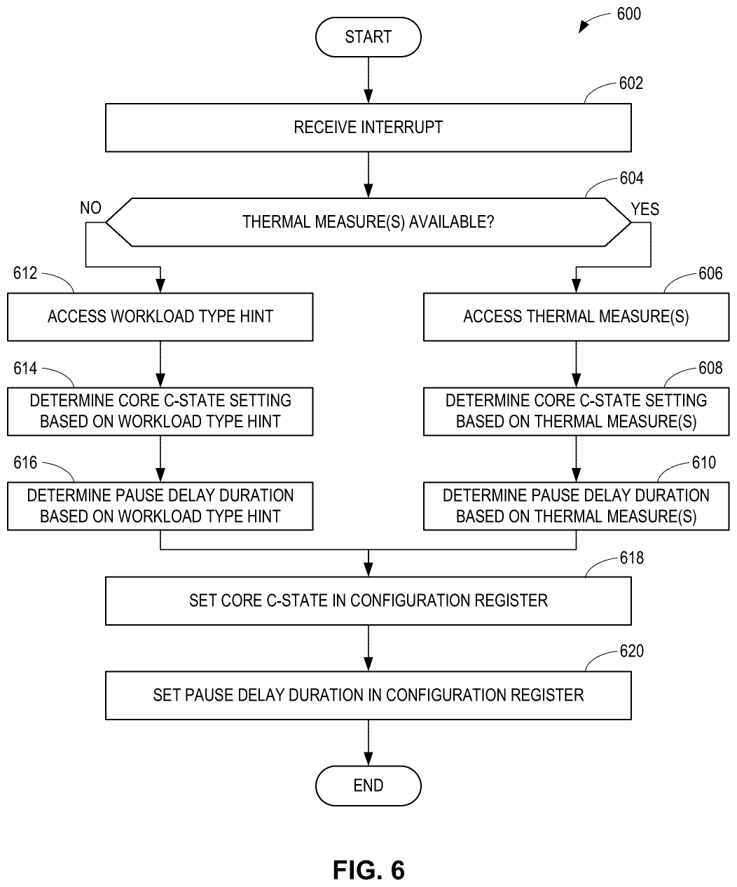

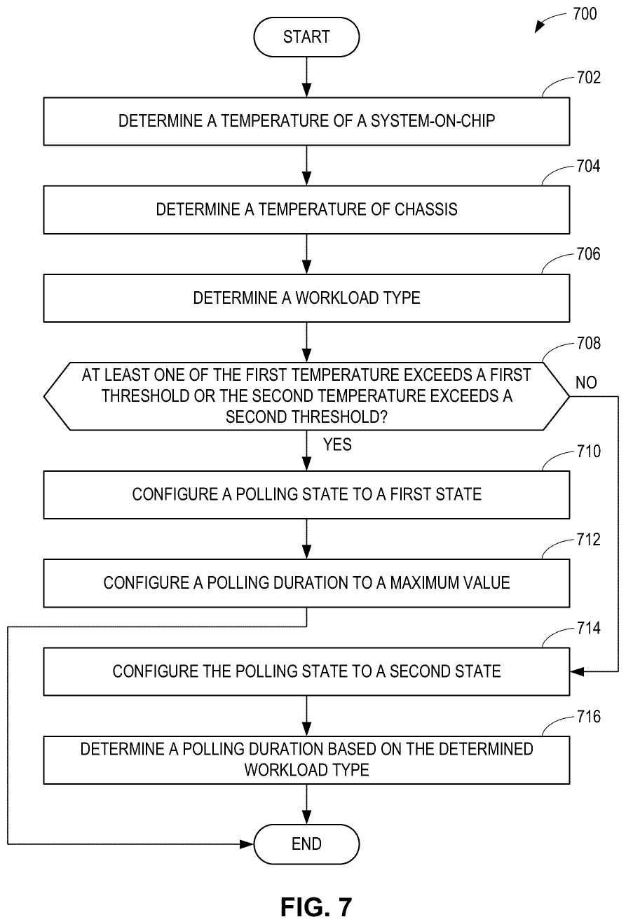

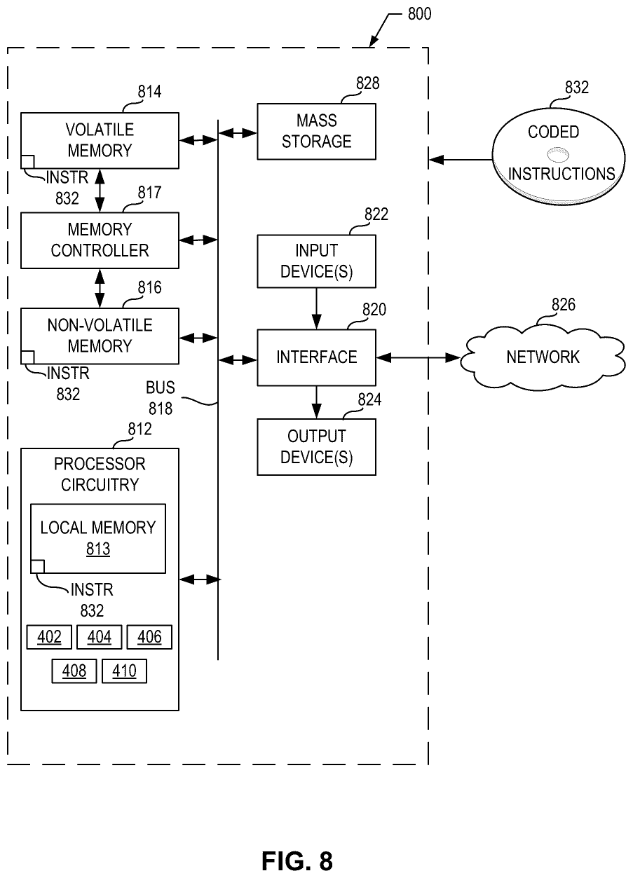

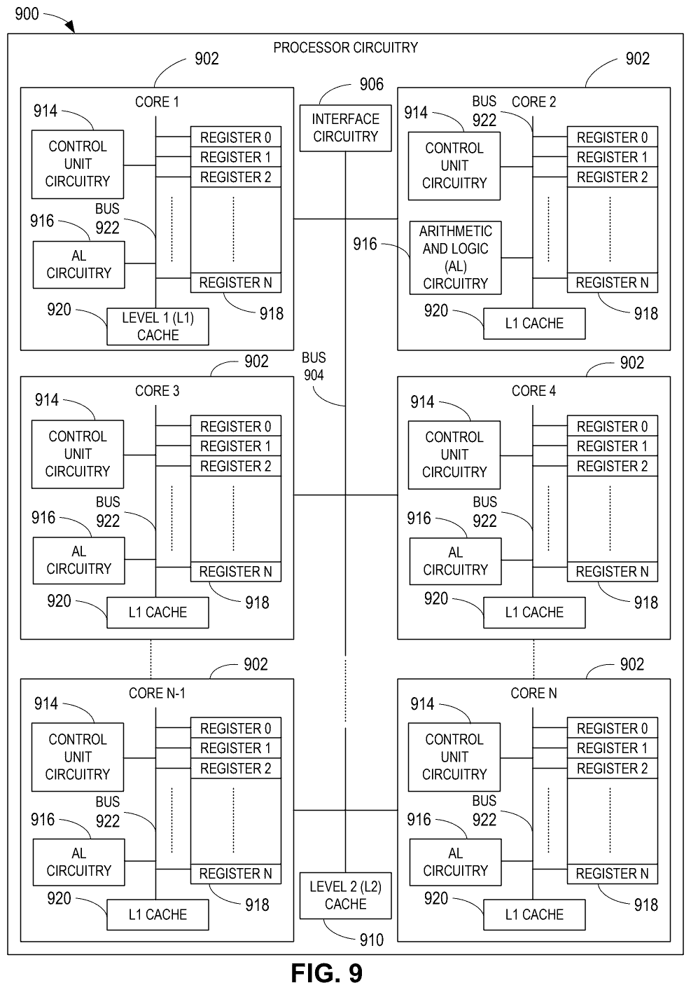

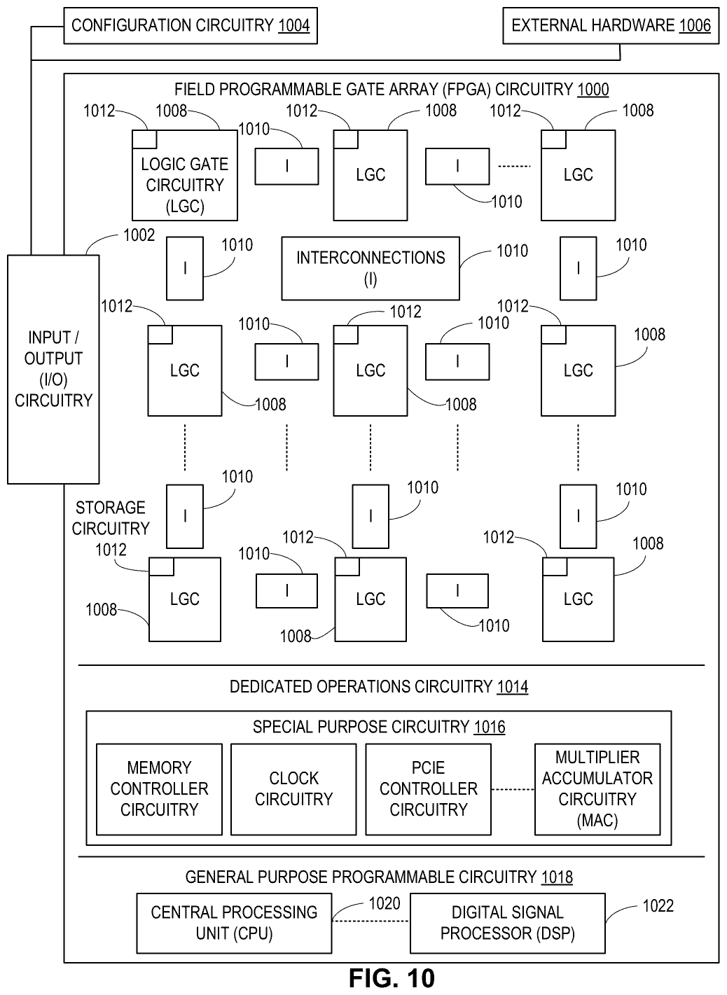

The example metrics interface circuitry 402 is provided to obtain metrics data. For example, the metrics interface circuitry 402 may obtain temperature measures from the chassis temperature sensor(s) 120 and the SoC temperature sensor 124. Additionally or alternatively, the metrics interface circuitry 402 may access metrics measures and/or workload type hints from the metrics data 128. In some examples, the metrics interface circuitry 402 is circuitry instantiated by programmable circuitry executing metrics interface instructions and/or configured to perform operations such as those represented by one or more of the flowcharts of FIGS. 5-7. In some examples, the processor capabilities manager 102 includes means for accessing metrics data. For example, the means for accessing the metrics data may be implemented by the metrics interface circuitry 402. In some examples, the metrics interface circuitry 402 may be instantiated by programmable circuitry such as the example programmable circuitry 812 of FIG. 8. For instance, the metrics interface circuitry 402 may be instantiated by the example microprocessor 900 of FIG. 9 executing machine-executable instructions such as those implemented by at least blocks 606 and 612 of FIG. 6 and blocks 702 and 704 of FIG. 7. In some examples, the metrics interface circuitry 402 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the metrics interface circuitry 402 may be instantiated by any other combination of hardware, software, and/or firmware. For example, the metrics interface circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example workload type hint generator circuitry 404 (e.g., workload type indicator generator circuitry) is provided to generate the workload type hints of FIG. 3 based on the metrics data 128 such as one or more of the host system pCPU's idle and utilization rates, energy-performance preference (EPP), system workload profiles, workload concurrency, performance/efficiency classification, power/thermal limitations, and/or any other suitable operating characteristic of the hardware 106. In some examples, the workload type hint generator circuitry 404 stores the workload type hints in the metric data 128.

In some examples, the workload type hint generator circuitry 404 includes a machine learning (ML) based algorithm trained on several workload profiles (e.g., system profiles), such as, bursty workloads, sustained workloads, battery life workloads, and idle workloads. The workload type ML algorithm can use different SoC telemetry data/counters (e.g., core utilization, concurrency of threads/cores, C-states, core frequency, etc.) from the pCPU 116 to classify different workloads into the different workload types (e.g., bursty, sustained, battery life, and idle). In some examples, the workload type hints generated by the workload type hint generator circuitry 404 are used by user space daemons to modify the Energy Performance Preference (EPP) of the pCPU 116 to make it power or performance centric.

In addition to the SoC telemetry data, the workload type hint generator can use thermal telemetry to determine the workload type hints of FIG. 3. For example, if the SoC temperature sensor 124 and/or the chassis temperature sensor 120 detect temperature(s) that reach(es)/exceed(s) acceptable/safe operating temperature threshold(s) (e.g., critical temperatures), the workload type hint generator circuitry 404 determines a workload type hint (e.g., a ‘battery life’ workload type hint or an ‘idle’ workload type hint of FIG. 3) that can be used by the processor capabilities manager 102 in response to the detected temperature(s) to dynamically increase the delay represented by the maximum pause delay duration value 132. Accordingly, the TPAUSE instruction 144 can be used to inject more idle periods into execution of the VM 112 based on the maximum pause delay duration value 132. Such longer idle periods help to cool the hardware 106 and substantially reduce or prevent the likelihood of SoC thermal shutdowns and/or cold reboots.

In some examples, the workload type hint generator circuitry 404 is circuitry instantiated by programmable circuitry executing workload type hint generator instructions and/or configured to perform operations such as those represented by one or more of the flowcharts of FIGS. 5-7.

In some examples, the processor capabilities manager 102 includes means for generating a workload type hint. For example, the means for generating the workload type hint may be implemented by the workload type hint generator circuitry 404. In some examples, the workload type hint generator circuitry 404 may be instantiated by programmable circuitry such as the example programmable circuitry 812 of FIG. 8. For instance, the workload type hint generator circuitry 404 may be instantiated by the example microprocessor 900 of FIG. 9 executing machine-executable instructions such as those implemented by at least block 706 of FIG. 7. In some examples, the workload type hint generator circuitry 404 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the workload type hint generator circuitry 404 may be instantiated by any other combination of hardware, software, and/or firmware. For example, the workload type hint generator circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example delay duration selector circuitry 406 is provided to select or determine delay values for the maximum pause delay duration value 132. For example, the delay duration selector circuitry 406 may determine the maximum pause delay duration value 132 based on thermal temperature measures from the chassis temperature sensor(s) 120 and/or chip temperature measures of the pCPU 116 from the SoC temperature sensor 124. Additionally or alternatively, the delay duration selector circuitry 406 may determine the maximum pause delay duration value 132 based on one or more of the workload type hints of FIG. 3. In some examples, the delay duration selector circuitry 406 is instantiated by programmable circuitry executing delay duration selector instructions and/or configured to perform operations such as those represented by one or more of the flowcharts of FIGS. 5-7.

In some examples, the processor capabilities manager 102 includes means for determining a delay duration value. For example, the means for determining the delay duration value may be implemented by the delay duration selector circuitry 406. In some examples, the delay duration selector circuitry 406 may be instantiated by programmable circuitry such as the example programmable circuitry 812 of FIG. 8. For instance, the delay duration selector circuitry 406 may be instantiated by the example microprocessor 900 of FIG. 9 executing machine-executable instructions such as those implemented by at least blocks 610 and 616 of FIG. 6 and blocks 712 and 716 of FIG. 7. In some examples, the delay duration selector circuitry 406 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the delay duration selector circuitry 406 may be instantiated by any other combination of hardware, software, and/or firmware. For example, the delay duration selector circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example core mode selector circuitry 408 is provided to select or determine the core C-state setting 134. For example, the core mode selector circuitry 408 may determine the core C-state setting 134 based on thermal temperature measures from the chassis temperature sensor(s) 120 and/or chip temperature of the pCPU 116 from the SoC temperature sensor 124. Additionally or alternatively, the core mode selector circuitry 408 may determine the core C-state setting 134 based on one or more of the workload type hints of FIG. 3. In some examples, the core mode selector circuitry 408 is instantiated by programmable circuitry executing core C-state selector instructions and/or configured to perform operations such as those represented by one or more of the flowcharts of FIGS. 5-7.

In some examples, the processor capabilities manager 102 includes means for determining a core C-state setting. For example, the means for determining a core C-state setting may be implemented by the core mode selector circuitry 408. In some examples, the core mode selector circuitry 408 may be instantiated by programmable circuitry such as the example programmable circuitry 812 of FIG. 8. For instance, the core mode selector circuitry 408 may be instantiated by the example microprocessor 900 of FIG. 9 executing machine-executable instructions such as those implemented by at least blocks 608 and 614 of FIG. 6 and blocks 710 and 714 of FIG. 7. In some examples, the core mode selector circuitry 408 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the core mode selector circuitry 408 may be instantiated by any other combination of hardware, software, and/or firmware. For example, the core mode selector circuitry 408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The register interface circuitry 410 is provided to access the configuration register 122. For example, the register interface circuitry 410 writes or loads the maximum pause delay duration value 132 and/or the core C-state setting 134 in corresponding fields of the configuration register 122. In some examples, the register interface circuitry 410 is instantiated by programmable circuitry executing register interface instructions and/or configured to perform operations such as those represented by one or more of the flowcharts of FIGS. 5-7.

In some examples, the processor capabilities manager 102 includes means for accessing a configuration register. For example, the means for accessing the configuration register may be implemented by the register interface circuitry 410. In some examples, the register interface circuitry 410 may be instantiated by programmable circuitry such as the example programmable circuitry 812 of FIG. 8. For instance, the register interface circuitry 410 may be instantiated by the example microprocessor 900 of FIG. 9 executing machine-executable instructions such as those implemented by at least blocks 618 and 620 of FIG. 6 and blocks 710, 712, 714, and 716 of FIG. 7. In some examples, the register interface circuitry 410 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the register interface circuitry 410 may be instantiated by any other combination of hardware, software, and/or firmware. For example, the register interface circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the processor capabilities manager 102 of FIG. 1 is illustrated in FIG. 4, one or more of the elements, processes, and/or devices illustrated in FIG. 4 may be combined, divided, re-arranged, omitted, eliminated, and/or implemented in any other way. Further, the example metrics interface circuitry 402, the example workload type hint generator circuitry 404, the example delay duration selector circuitry 406, the example core mode selector circuitry 408, and the example register interface circuitry 410, and/or, more generally, the example processor capabilities manager 102 of FIG. 4, may be implemented by hardware alone or by hardware in combination with software and/or firmware. Thus, for example, any of the example metrics interface circuitry 402, the example workload type hint generator circuitry 404, the example delay duration selector circuitry 406, the example core mode selector circuitry 408, and the example register interface circuitry 410, and/or, more generally, the example processor capabilities manager 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example processor capabilities manager 102 of FIG. 4 may include one or more elements, processes, and/or devices in addition to, or instead of, those illustrated in FIG. 4, and/or may include more than one of any or all of the illustrated elements, processes and devices.

Flowcharts representative of example machine readable instructions, which may be executed by programmable circuitry to implement and/or instantiate the processor capabilities manager 102 of FIG. 4 and/or representative of example operations which may be performed by programmable circuitry to implement and/or instantiate the processor capabilities manager 102 of FIG. 4, are shown in FIGS. 5-7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 5-7, many other methods of implementing the example processor capabilities manager 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-7 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by example programmable circuitry to implement the virtual computing environment 100 of FIG. 1 to halt an idle one of the vCPUs 142a-c (FIGS. 1 and 2). The example machine-readable instructions and/or the example operations 500 of FIG. 5 begin at block 502, at which the processor capabilities manager 102 (FIGS. 1, 2, and 4) dynamically sets the maximum pause delay duration value 132 and the core C-state setting 134 in the configuration register 122 of FIGS. 1 and 2. Example operations that may be used to implement block 502 are described below in connection with FIGS. 6 and 7.

At block 504, a guest OS of the VM 112 (FIGS. 1 and 2) detects an idle vCPU. For example the guest OS detects that one of the vCPUs 142a-c (FIGS. 1 and 2) has entered into an idle state (e.g., the vCPU is not processing any threads). At block 506, the guest OS executes the TPAUSE instruction 144 (FIGS. 1 and 2) based on the maximum pause delay duration value 132 in the configuration register 122. For example, the guest OS accesses the maximum pause delay duration value 132 in the configuration register 122 using a hypervisor call through the VMM 110 and sets a pause duration of the TPAUSE instruction 144 for the idle one of the vCPUs 142a-c based on the maximum pause delay duration value 132. In the illustrated example of FIG. 5, the guest OS kernel of the VM 112 executes the TPAUSE instruction 144 as a VMX non-root operation. At block 508, the guest OS determines whether a wake-up interrupt is detected. For example, the guest OS may receive a wake-up interrupt to notify the idle one of the vCPUs 142a-c of a pending thread awaiting to be processed. If a wake-up interrupt has not been detected (block 508: NO), control advances to block 512. Otherwise, if a wake-up interrupt is detected, the guest OS wakes the idle one of the vCPUs 142a-c (block 510). For example, the guest OS can wake the idle one of the vCPUs 142a-c by scheduling a received thread to be processed by that vCPU. Control then returns to block 502.

At block 512, the guest OS determines whether the maximum pause delay duration value 132 has expired. If the maximum pause delay duration value 132 has not expired (block 512: NO), control returns to block 508. If the maximum pause delay duration value 132 has expired (block 512: YES), the guest OS executes an HLT instruction (block 514). For example, the guest OS kernel of the VM 112 executes the HLT instruction for the idle one of the vCPUs 142a-c as a VMX non-root operation as depicted at block 204 of FIG. 2. As also shown, in FIG. 2, executing of the HLT instruction causes a VM Exit event 206. The instructions and/or operations 500 of FIG. 5 end.

FIG. 6 is a flowchart representative of example machine-readable instructions and/or example operations 600 that may be executed, instantiated, and/or performed by example programmable circuitry to implement the processor capabilities manager 102 FIG. 4 to dynamically set the maximum pause delay duration value 132 and the core C-state setting 134 in the configuration register 122 of the pCPU 116 of FIGS. 1 and 2. The instructions and/or operations 600 may be performed synchronously and/or asynchronously to dynamically set the maximum pause delay duration value 132 and/or the core C-state setting 134. Accordingly, the setting of the maximum pause delay duration value 132 and/or the core C-state setting 134 need not be performed synchronously with the execution of the TPAUSE instruction 144. Instead, the setting of the maximum pause delay duration value 132 and/or the core C-state setting 134 may be performed asynchronously relative to the execution of the TPAUSE instruction 144. As such, the maximum pause delay duration value 132 and the core C-state setting 134 are available in the configuration register 122 for access by the guest OS kernel of the VM 112 whenever the guest OS kernel of the VM 112 is to execute the TPAUSE instruction 144 to implement a delay based on the maximum pause delay duration value 132.

The example instructions and/or operations 600 may be used to implement block 502 of FIG. 5. The example instructions and/or operations 600 begin at block 602 at which the processor capabilities manager 102 receives an interrupt. For example, the processor capabilities manager 102 may receive an interrupt indicating that it is time for the processor capabilities manager 102 to dynamically adjust the maximum pause delay duration value 132 and/or the core C-state setting 134. The interrupt may be a timer-based interrupt from a timer that is set to countdown an interval duration provided by the processor capabilities manager 102. Additionally or alternatively, the interrupt may indicate a detected change in the metrics data 128 (e.g., a change to one or more of a chassis temperature collected from the chassis temperature sensor(s) 120, a chip temperature collected from the SoC temperature sensor 124, an idle rate of one or more pCPUs of the hardware 106, a utilization rate of the one or more pCPUs, an energy-performance preference, system workload profiles, a workload concurrency, a performance classification, an efficiency classification, a power limitation of the hardware 106, or a thermal limitation of the hardware 106). In some examples, the interrupt of block 602 is a “Processor Hot” interrupt (e.g., a PROCHOT# interrupt) from the pCPU 116.

At block 604, the metrics interface circuitry 402 determines whether one or more thermal measure(s) are available. For example, the metrics interface circuitry 402 may obtain the thermal measure(s) directly from the one or more chassis temperature sensor(s) 120 and/or the SoC temperature sensor 124. Additionally or alternatively, the metrics interface circuitry 402 may obtain the thermal measure(s) from the metrics data 128. If the metrics interface circuitry 402 determines that one or more thermal measure(s) are not available (block 604: NO), control advances to block 612. Otherwise, if the metrics interface circuitry 402 determines that one or more thermal measure(s) are available (block 604: YES), the metrics interface circuitry 402 accesses the thermal measure(s) (block 606). For example, the metrics interface circuitry 402 can access one or more chassis temperature measurements from the one or more chassis temperature sensor(s) 120 and/or access a chip temperature measurement of the pCPU 116 from the SoC temperature sensor 124. Additionally or alternatively, the metrics interface circuitry 402 can access one or more of the thermal measure(s) from the metrics data 128.

At block 608, the core mode selector circuitry 408 determines or selects the core C-state setting 134 based on the one or more thermal measure(s). The core mode selector circuitry 408 can select from any suitable performance or power saving setting for one or more cores of the pCPU 116 based on the one or more thermal measure(s) corresponding to the hardware 106. For example, the core mode selector circuitry 408 can set the core C-state setting 134 as the performance mode or the power saving mode of FIG. 3 based on a comparison of the chip temperature of the pCPU 116 to at least one of a chip temperature threshold or a chassis temperature threshold. In other examples, the core mode selector circuitry 408 sets the core C-state setting 134 as the performance mode or the power saving mode of FIG. 3 based on a comparison of one or more chassis temperatures from one or more of the chassis temperature sensors 120 to one or more chassis temperature thresholds (e.g., temperature thresholds corresponding to different locations on a motherboard or chassis of the hardware 106).

At block 610, the delay duration selector circuitry 406 determines or selects the maximum pause delay duration value 132 based on the one or more thermal measure(s). The delay duration selector circuitry 406 can determine or select any suitable delay duration to poll the idle one of the vCPUs 142a-c based on the one or more thermal measure(s) corresponding to the hardware 106. The delay duration selector circuitry 406 may use a chip temperature of the pCPU 116 from the SoC temperature sensor 124 and/or one or more chassis temperature(s) from the one or more chassis temperature sensor(s) 120. For example, the delay duration selector circuitry 406 can compare the chip temperature of the pCPU 116 and/or the one or more chassis temperature(s) to a chip temperature threshold and/or one or more chassis temperature threshold(s). The delay duration selector circuitry 406 can use these comparisons to determine whether the pCPU 116 and/or different parts of the hardware 106 in a chassis are operating within acceptable temperature conditions so that the pCPU 116 can operate at a higher performance mode or whether the pCPU 116 and/or different parts of the hardware 106 in a chassis are operating too hot such that the pCPU 116 is operating at a lower performance mode to allow cooling of the pCPU 116. If the delay duration selector circuitry 406 determines that the temperature information indicates the pCPU 116 is operating at a high performance mode, the delay duration selector circuitry 406 can select a relatively shorter duration for the maximum pause delay duration value 132 than if the temperature information indicates the pCPU 116 operating at a lower performance mode. If the delay duration selector circuitry 406 determines that the temperature information indicates the pCPU 116 is operating at a low performance mode (e.g., a higher power savings mode), the delay duration selector circuitry 406 can select a relatively longer duration for the maximum pause delay duration value 132.

In some examples, the delay duration selector circuitry 406 uses temperature measures in combination with workload type hints from the parameter configurations table 300 (FIG. 3) to determine or select the maximum pause delay duration value 132 at block 610. For example, the delay duration selector circuitry 406 can retrieve the maximum pause delay duration value 132 from the parameter configurations table 300 based on the workload type hint and adjust the maximum pause delay duration value 132 based on a chip temperature of the pCPU 116 from the SoC temperature sensor 124 and/or one or more chassis temperature(s) from the one or more chassis temperature sensor(s) 120. Accordingly, the maximum pause delay duration value 132 can dynamically adjust the maximum pause delay duration value 132 provided as a default value in the parameter configurations table 300 to be more relevant to substantially real-time thermal measures of the hardware 106.

At block 612, the metrics interface circuitry 402 accesses a workload type hint corresponding to one of more workloads executed on the VM 112 hosted by the hardware 106. For example, the metrics interface circuitry 402 accesses one of the workload type hints of FIG. 3 from the metrics data 128. At block 614, the core mode selector circuitry 408 determines or selects the core C-state setting 134 based on the workload type hint. For example, the core mode selector circuitry 408 can determine or select the core C-state setting 134 from the parameter configurations table 300 based on the workload type hint. At block 616, the delay duration selector circuitry 406 determines or selects the maximum pause delay duration value 132 based on the workload type hint. For example, the delay duration selector circuitry 406 can determine or select the maximum pause delay duration value 132 from the parameter configurations table 300 of FIG. 3 based on the workload type hint.

At block 618, the register interface circuitry 410 sets or loads the core C-state setting 134 in the configuration register 122. At block 620, the register interface circuitry 410 sets or loads the maximum pause delay duration value 132 in the configuration register 122. The example instructions and/or operations 600 end.

FIG. 7 is another flowchart representative of example machine-readable instructions and/or example operations 700 that may be executed, instantiated, and/or performed by example programmable circuitry to implement the processor capabilities manager 102 of FIG. 4 to dynamically set the maximum pause delay duration value 132 and the core C-state setting 134 in the configuration register 122 of the pCPU 116 of FIGS. 1 and 2. The example instructions and/or operations 700 may be used to implement block 502 of FIG. 5. The example instructions and/or operations 700 begin at block 702, at which the processor capabilities manager 102 determines a first temperature of an SoC (e.g., the pCPU 116). In some examples, the processor capabilities manager 102 determines the first temperature based on information from a hardware interface (e.g., an Enhanced Hardware Feedback Interface (“EHFI”)) of the SoC. The processor capabilities manager 102 may determine the first temperature based on a first output of a first sensor (e.g., the SoC temperature sensor 124) on the SoC. For example, the metrics interface circuitry 402 may retrieve the first temperature from the SoC temperature sensor 124. At block 704, the processor capabilities manager 102 determines a second temperature of a chassis. In some examples, the processor capabilities manager 102 determines the second temperature based on an output of a second sensor (e.g., the chassis temperature sensor(s) 120) on the chassis. For example, the metrics interface circuitry 402 may retrieve the second from the chassis temperature sensor(s) 120. At block 706, the processor capabilities manager 102 determines a workload type. In some examples, the processor capabilities manager determines the workload type (e.g., a workload type hint of FIG. 3) based on at least one of a host system CPU's idle and utilization rates, an EPP, a system workload profile, a workload concurrency, a performance classification, an efficiency classification, power limitations, and/or thermal limitations. For example, the workload type hint generator circuitry 404 may determine the workload type.

At block 708, the processor capabilities manager 102 determines whether at least one of the first temperature or the second temperature exceeds a respective first threshold or second threshold. For example, the processor capabilities manager 102 determines whether the temperature of the SoC exceeds a first threshold value. In some examples, the first threshold value corresponds to a temperature above which the SoC may incur thermal damage. For example, the first threshold value may be 194 degrees Fahrenheit (90 degrees Celsius). If at least one of the first temperature or the second temperature exceeds a respective first threshold or second threshold (block 708: YES), control continues to block 710, at which the processor capabilities manager 102 configures a polling state to a first state corresponding to a high power savings state. For example, the processor capabilities manager 102 determines the polling state and stores or loads the polling state into the configuration register 122. In some examples, the core mode selector circuitry 408 determines the polling state and the register interface circuitry 410 stores or loads the polling state in the configuration register 122. At block 712, the processor capabilities manager 102 configures a polling duration to a maximum value. For example, the processor capabilities manager 102 determines the polling duration and stores or loads the polling duration into the configuration register 122. In some examples, the delay duration selector circuitry 406 determines the polling duration and the register interface circuitry 410 stores or loads the polling duration in the configuration register 122. In some examples, the example instructions and/or operations 700 end. In other examples, control returns to block 702.

Returning to block 708, if neither of the first temperature or the second temperature exceeds the respective first threshold or second threshold (block 708: NO), the example instructions and/or operations 700 continue to block 714, at which the processor capabilities manager 102 configures the polling state to a second state corresponding to a performance mode state. For example, the processor capabilities manager 102 determines the polling state and stores or loads the polling state into the configuration register 122. In some examples, the core mode selector circuitry 408 determines the polling state and the register interface circuitry 410 stores or loads the polling state in the configuration register 122. At block 716, the processor capabilities manager 102 determines the polling duration based on the determined workload type. For example, the processor capabilities manager 102 determines the polling duration and stores or loads the polling duration into the configuration register 122. In some examples, the delay duration selector circuitry 406 determines the polling duration and the register interface circuitry 410 stores or loads the polling duration in the configuration register 122. In some examples, the instructions and/or operations 700 end. In other examples, control returns to block 702.

FIG. 8 is a block diagram of an example programmable circuitry platform 800 structured to execute and/or instantiate the example machine-readable instructions and/or the example operations of FIGS. 5-7 to implement the processor capabilities manager 102 of FIG. 4. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a set top box, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the metrics interface circuitry 402, the workload type hint generator circuitry 404, the delay duration selector circuitry 406, the core mode selector circuitry 408, and the register interface circuitry 410. In some examples, the memory 118 may also be in the programmable circuitry 812.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. In some examples, the memory 118 is implemented by the volatile memory 814 and/or the non-volatile memory 816. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIGS. 5-7, may be stored in the mass storage device 828, in the volatile memory 814, in the non-volatile memory 816, and/or on at least one non-transitory computer-readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 5-7 to effectively instantiate the circuitry of FIG. 4 as logic circuits to perform operations corresponding to those machine-readable instructions. In some such examples, the circuitry of FIG. 4 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine-readable instructions and/or operations represented by the flowcharts of FIGS. 5-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCI bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCI bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine-readable instructions. However, once configured, the FPGA circuitry 1000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine-readable instructions represented by the flowchart(s) of FIGS. 5-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-7. As such, the FPGA circuitry 1000 may be configured and/or structured to effectively instantiate some or all of the operations/functions corresponding to the machine-readable instructions of the flowchart(s) of FIGS. 5-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine-readable instructions of FIGS. 5-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine-readable instructions of FIGS. 5-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCI controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine-readable instructions represented by the flowchart(s) of FIGS. 5-7 to perform first operation(s)/function(s), the FPGA circuitry 1000 of FIG. 10 may be configured and/or structured to perform second operation(s)/function(s) corresponding to a second portion of the machine-readable instructions represented by the flowcharts of FIG. 5-7, and/or an ASIC may be configured and/or structured to perform third operation(s)/function(s) corresponding to a third portion of the machine-readable instructions represented by the flowcharts of FIGS. 5-7.

It should be understood that some or all of the circuitry of FIG. 4 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 900 of FIG. 9 may execute machine-readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 4 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

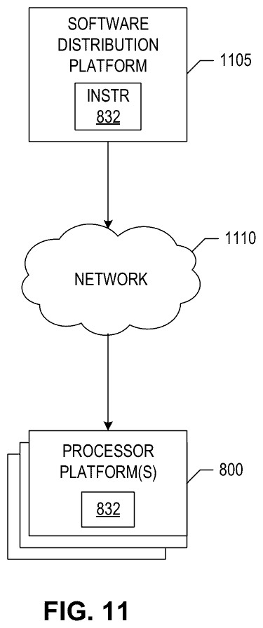

A block diagram illustrating an example software distribution platform 1105 to distribute software such as the example machine-readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine-readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine-readable instructions 832, which may correspond to the example machine-readable instructions of FIGS. 5-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 832 from the software distribution platform 1105. For example, the software, which may correspond to the example machine-readable instructions of FIG. 5-7, may be downloaded to the example programmable circuitry platform 800, which is to execute the machine-readable instructions 832 to implement the processor capabilities manager 102. In some examples, one or more servers of the software distribution platform 1105 periodically offer, transmit, and/or force updates to the software (e.g., the example machine-readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” and “substantially real-time” refer to occurrence in a near instantaneous manner recognizing there may be real-world delays for computing time, transmission, etc. Thus, unless otherwise specified, “substantially real time” and “substantially real-time” refer to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that dynamically configure delay durations and/or core power states in virtual computing environments. Disclosed systems, apparatus, articles of manufacture, and methods may improve the efficiency of using a computing device by reducing overhead from VM Exit events (e.g., VM Exit HLT events), which conserves CPU cycles and improves processing performance on hybrid platforms that use P-cores and E-cores, by enhancing battery life for VM scenarios through efficient usage and polling of P-cores and E-cores on hybrid platforms, by dynamically adjusting core C-states and maximum pause delay durations in substantially real time based on substantially real-time thread characteristic data provided by an EHFI of hardware, and/or by improving hardware power efficiency through power savings due to optimized pCPU resource utilization by implementing more power-optimized states of virtual environments during vCPU idle periods. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to dynamically configure delay durations and/or core power states in virtual computing environments are disclosed herein. Further examples and combinations thereof include the following:

Example 1 includes an apparatus comprising a configuration register, machine-readable instructions, and at least one processor circuit to be programmed by the machine-readable instructions to access a workload type indicator associated with a workload executed on a virtual machine hosted by the apparatus, and set a delay duration in the configuration register, the delay duration based on at least one of the workload type indicator or a temperature measurement value corresponding to hardware.

Example 2 includes the apparatus of example 1, wherein one or more of the at least one processor circuit is to set a core power state in the configuration register, the core power state based on the workload type indicator.

Example 3 includes the apparatus of at least one of example 1 or example 2, wherein the temperature measurement value is a chip temperature of the at least one processor circuit, one or more of the at least one processor circuit to set the core power state as a performance mode or a power saving mode based on a comparison of the chip temperature to at least one of a chip temperature threshold or a chassis temperature threshold.

Example 4 includes the apparatus of at least one of examples 1-3, wherein the workload type indicator is based on at least one of an idle rate of one or more of the at least one processor circuit, a utilization rate of the one or more of the at least one processor circuit, an energy performance preference, a workload concurrency, a performance classification, an efficiency classification, a power limitation of the hardware, or a thermal limitation of the hardware.

Example 5 includes the apparatus of at least one of examples 1-4, wherein one or more of the at least one processor circuit is to access the workload type indicator as at least one of bursty, sustained, battery life, or idle.

Example 6 includes the apparatus of at least one of examples 1-5, wherein the configuration register is a model-specific register of one or more of the at least one processor circuit.

Example 7 includes the apparatus of at least one of examples 1-6, wherein one or more of the at least one processor circuit is to after a virtual processor of the virtual machine enters an idle state, implement a pause duration of the virtual processor based on the delay duration from the configuration register, and after expiration of the delay duration, execute a halt instruction for the virtual processor.

Example 8 includes At least one non-transitory machine-readable medium comprising machine-readable instructions to cause at least one processor circuit to at least access a workload type indicator associated with a workload executed on a virtual machine, and set a delay duration in a configuration register, the delay duration based on at least one of the workload type indicator or a temperature measurement value corresponding to hardware.

Example 9 includes the at least one non-transitory machine-readable medium of example 8, wherein the machine-readable instructions are to cause one or more of the at least one processor circuit to set a core power state in the configuration register, the core power state based on the workload type indicator.

Example 10 includes the at least one non-transitory machine-readable medium of at least one of example 8 or example 9, wherein the temperature measurement value is a chip temperature of the at least one processor circuit, the machine-readable instructions are to cause one or more of the at least one processor circuit to set the core power state as a performance mode or a power saving mode based on a comparison of the chip temperature to at least one of a chip temperature threshold or a chassis temperature threshold.

Example 11 includes the at least one non-transitory machine-readable medium of at least one of examples 8-10, wherein the workload type indicator is based on at least one of an idle rate of one or more of the at least one processor circuit, a utilization rate of the one or more of the at least one processor circuit, an energy performance preference, a workload concurrency, a performance classification, an efficiency classification, a power limitation of the hardware, or a thermal limitation of the hardware.

Example 12 includes the at least one non-transitory machine-readable medium of at least one of examples 8-11, wherein the machine-readable instructions are to cause one or more of the at least one processor circuit to access the workload type indicator as at least one of bursty, sustained, battery life, or idle.

Example 13 includes the at least one non-transitory machine-readable medium of at least one of examples 8-12, wherein the configuration register is a Memory-Mapped Input-Output register of one or more of the at least one processor circuit.

Example 14 includes the at least one non-transitory machine-readable medium of at least one of examples 8-13, wherein the machine-readable instructions are to cause one or more of the at least one processor circuit to after a virtual processor of the virtual machine enters an idle state, pause the virtual processor based on the delay duration from the configuration register, and after expiration of the delay duration, execute a halt instruction to halt the virtual processor.

Example 15 includes an apparatus comprising metrics interface circuitry to access a workload type indicator associated with a workload executed on a virtual machine hosted by the apparatus, delay duration selector circuitry to determine a delay duration based on at least one of the workload type indicator or a temperature measurement value corresponding to hardware, and register interface circuitry to set the delay duration in a configuration register of a processor.

Example 16 includes the apparatus of example 15, including core mode selector circuitry to select a core power state based on the workload type indicator, the register interface circuitry to set the core power state in the configuration register.

Example 17 includes the apparatus of at least one of example 15 or example 16, wherein the temperature measurement value is a chip temperature of the processor, the core mode selector circuitry to select the core power state as a performance mode or a power saving mode based on a comparison of the chip temperature to at least one of a chip temperature threshold or a chassis temperature threshold.

Example 18 includes the apparatus of at least one of examples 15-17, wherein the workload type indicator is based on at least one of an idle rate of the processor, a utilization rate of the processor, an energy performance preference, a workload concurrency, a performance classification, an efficiency classification, a power limitation of the hardware, or a thermal limitation of the hardware.

Example 19 includes the apparatus of at least one of examples 15-18, wherein the metrics interface circuitry is to access the workload type indicator as at least one of bursty, sustained, battery life, or idle.

Example 20 includes the apparatus of at least one of examples 15-19, including a guest operating system of the virtual machine, the guest operating system to after a virtual processor of the virtual machine enters an idle state, execute a pause instruction based on the delay duration from the configuration register, the pause instruction to pause halting of the virtual processor, and after expiration of the delay duration, execute a halt instruction to halt the virtual processor.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a configuration register;
machine-readable instructions; and
at least one processor circuit to be programmed by the machine-readable instructions to:
access a workload type indicator associated with a workload executed on a virtual machine hosted by the apparatus; and
set a delay duration in the configuration register, the delay duration based on at least one of the workload type indicator or a temperature measurement value corresponding to hardware.

2. The apparatus of claim 1, wherein one or more of the at least one processor circuit is to set a core power state in the configuration register, the core power state based on the workload type indicator.

3. The apparatus of claim 2, wherein the temperature measurement value is a chip temperature of the at least one processor circuit, one or more of the at least one processor circuit to set the core power state as a performance mode or a power saving mode based on a comparison of the chip temperature to at least one of a chip temperature threshold or a chassis temperature threshold.

4. The apparatus of claim 1, wherein the workload type indicator is based on at least one of an idle rate of one or more of the at least one processor circuit, a utilization rate of the one or more of the at least one processor circuit, an energy performance preference, a workload concurrency, a performance classification, an efficiency classification, a power limitation of the hardware, or a thermal limitation of the hardware.

5. The apparatus of claim 1, wherein one or more of the at least one processor circuit is to access the workload type indicator as at least one of bursty, sustained, battery life, or idle.

6. The apparatus of claim 1, wherein the configuration register is a model-specific register of one or more of the at least one processor circuit.

7. The apparatus of claim 1, wherein one or more of the at least one processor circuit is to:
after a virtual processor of the virtual machine enters an idle state, implement a pause duration of the virtual processor based on the delay duration from the configuration register; and
after expiration of the delay duration, execute a halt instruction for the virtual processor.

8. At least one non-transitory machine-readable medium comprising machine-readable instructions to cause at least one processor circuit to at least:
access a workload type indicator associated with a workload executed on a virtual machine; and
set a delay duration in a configuration register, the delay duration based on at least one of the workload type indicator or a temperature measurement value corresponding to hardware.

9. The at least one non-transitory machine-readable medium of claim 8, wherein the machine-readable instructions are to cause one or more of the at least one processor circuit to set a core power state in the configuration register, the core power state based on the workload type indicator.

10. The at least one non-transitory machine-readable medium of claim 9, wherein the temperature measurement value is a chip temperature of the at least one processor circuit, the machine-readable instructions are to cause one or more of the at least one processor circuit to set the core power state as a performance mode or a power saving mode based on a comparison of the chip temperature to at least one of a chip temperature threshold or a chassis temperature threshold.

11. The at least one non-transitory machine-readable medium of claim 8, wherein the workload type indicator is based on at least one of an idle rate of one or more of the at least one processor circuit, a utilization rate of the one or more of the at least one processor circuit, an energy performance preference, a workload concurrency, a performance classification, an efficiency classification, a power limitation of the hardware, or a thermal limitation of the hardware.

12. The at least one non-transitory machine-readable medium of claim 8, wherein the machine-readable instructions are to cause one or more of the at least one processor circuit to access the workload type indicator as at least one of bursty, sustained, battery life, or idle.

13. The at least one non-transitory machine-readable medium of claim 8, wherein the configuration register is a Memory-Mapped Input-Output register of one or more of the at least one processor circuit.

14. The at least one non-transitory machine-readable medium of claim 8, wherein the machine-readable instructions are to cause one or more of the at least one processor circuit to:
after a virtual processor of the virtual machine enters an idle state, pause the virtual processor based on the delay duration from the configuration register; and
after expiration of the delay duration, execute a halt instruction to halt the virtual processor.

15. An apparatus comprising:
metrics interface circuitry to access a workload type indicator associated with a workload executed on a virtual machine hosted by the apparatus;
delay duration selector circuitry to determine a delay duration based on at least one of the workload type indicator or a temperature measurement value corresponding to hardware; and
register interface circuitry to set the delay duration in a configuration register of a processor.

16. The apparatus of claim 15, including core mode selector circuitry to select a core power state based on the workload type indicator, the register interface circuitry to set the core power state in the configuration register.

17. The apparatus of claim 16, wherein the temperature measurement value is a chip temperature of the processor, the core mode selector circuitry to select the core power state as a performance mode or a power saving mode based on a comparison of the chip temperature to at least one of a chip temperature threshold or a chassis temperature threshold.

18. The apparatus of claim 15, wherein the workload type indicator is based on at least one of an idle rate of the processor, a utilization rate of the processor, an energy performance preference, a workload concurrency, a performance classification, an efficiency classification, a power limitation of the hardware, or a thermal limitation of the hardware.

19. The apparatus of claim 15, wherein the metrics interface circuitry is to access the workload type indicator as at least one of bursty, sustained, battery life, or idle.

20. The apparatus of claim 15, including a guest operating system of the virtual machine, the guest operating system to:
after a virtual processor of the virtual machine enters an idle state, execute a pause instruction based on the delay duration from the configuration register, the pause instruction to pause halting of the virtual processor; and
after expiration of the delay duration, execute a halt instruction to halt the virtual processor.
